(19) United States
(12) Patent Application Publication
(10) Pub. No.: US 2023/0354136 A1
(43) Pub. Date: Nov. 2, 2023

(54) INTEGRATED ACCESS AND BACKHAUL COMMUNICATION METHOD AND APPARATUS

(71) Applicant: FUJITSU LIMITED, Kawasaki-shi (JP)

(72) Inventors: Guorong LI, Beijing (CN); Meiyi JIA, Beijing (CN); Yang LU, Beijing (CN); Su YI, Beijing (CN)

(73) Assignee: FUJITSU LIMITED, Kawasaki-shi (JP)

(21) Appl. No.: 18/220,345

(22) Filed: Jul. 11, 2023

Related U.S. Application Data
(63) Continuation of application No. PCT/CN2021/071577, filed on Jan. 13, 2021.

(51) Int. Cl. H04B 7/06; H04W 36/30

(52) U.S. Cl. CPC H04W 36/305; H04B 7/06964

(57) ABSTRACT

An integrated access and backhaul (IAB) communication method includes detecting, by an IAB node, that on a backhaul link between the IAB node and a parent node, a radio link failure (RLF) occurs or a radio link failure (RLF) recovery is successful, or a radio link failure (RLF) recovery is failure, and transmitting, by the IAB node, RLF indication information to an IAB child node or a terminal equipment by using a Backhaul Adaptation Protocol (BAP) control Protocol Data Unit (PDU), the RLF indication information being used for indicating one of at least two backhaul radio link failure (BH RLF) types.

### CROSS-REFERENCE TO RELATED APPLICATION

This application is a continuation application of International Application PCT/CN2021/071577 filed on Jan. 13, 2021, and designated the U.S., the entire contents of which are incorporated herein by reference

### TECHNICAL FIELD

This disclosure relates to the field of communication technologies.

### BACKGROUND

Integrated access and backhaul (IAB) enables a 5G Radio Access Network (RAN) to support radio relay. A relay node is called an IAB node and supports access and backhaul via an NR. A termination point of an NR backhaul on a network side is called an IAB-donor (which may also be regarded as an IAB node), which represents a gNB that has a function of supporting the IAB. The backhaul may occur via a single hop or multiple hops.

The IAB node supports a function of a gNB-DU (Distributed Unit), that is, IAB-DU. The IAB-DU is terminated to an NR access interface of terminal equipment and a next-hop IAB node, and to an F1 protocol of a gNB-CU (Centralized Unit) function on the IAB-donor. IAB node DUs may also be referred to as IAB-DUs.

In addition to the gNB-DU (Distributed Unit) function, the IAB node also supports a part of terminal equipment functions (UE functions), which can be called IAB-MT. For example, the IAB-MT includes functions of a physical layer, a layer 2 (L2), a radio resource control (RRC) and a non-access stratum (NAS), to connect to another IAB node or the gNB-DU of the IAB-donor, to connect to the gNB-CU of the IAB-donor and to connect to a core network.

The IAB node is connected to the IAB-donor by one or more hops. In a topology, the IAB-donor is a root node, and adjacent nodes of an IAB-DU interface of the IAB node are called descendant nodes or child nodes, i.e., descendant IAB nodes, of the IAB node, and adjacent nodes of an IAB-MT interface is called parent nodes, i.e., IAB parent nodes. A direction to the child nodes is further referred to as downstream, whereas a direction to the parent nodes is referred to as upstream. The IAB-donor performs centralized resource, topology and routing management for this IAB topology.

It should be noted that the above description of the background art is merely provided for clear and complete explanation of this disclosure and for easy understanding by those skilled in the art. And it should not be understood that the above technical solution is known to those skilled in the art as it is described in the background art of this disclosure.

### SUMMARY

However, the inventors found that in a case where an inter-centralized unit (inter-CU) recovery or handover was supported, it was assumed that the IAB child node or the terminal equipment migrated together with the IAB node after recovery or after handover (or referred to as after migration) to a target IAB-donor CU. Since the IAB child node or the terminal equipment did not change the serving IAB node, the IAB child node or the terminal equipment may not actively initiate a reestablishment, and may not update configuration information of the CU (such as a security key or other parameters), which results in that it cannot properly communicate with the target CU.

For at least one of the problems, the embodiments of this disclosure provide an integrated access and backhaul (IAB) communication method and apparatus.

According to an aspect of the embodiments of this disclosure, there is provided an integrated access and backhaul (IAB) communication method, including:
receiving, by an IAB child node or terminal equipment, indication information transmitted by a network device; the indication information being used to indicate that the IAB child node or the terminal equipment deems that a radio link failure (RLF) is detected or indicate that the IAB child node or the terminal equipment initiates a connection reestablishment in a case where an IAB node where the IAB child node or the terminal equipment is present performs an inter-centralized unit (inter-CU) recovery or migration; and
initiating, by the IAB child node or the terminal equipment, a radio link failure recovery process or a connection reestablishment process.

According to another aspect of the embodiments of this disclosure, there is provided an integrated access and backhaul (IAB) communication apparatus, including:
a receiving portion configured to receive indication information transmitted by a network device, the indication information being used to indicate that an IAB child node or terminal equipment deems that a radio link failure (RLF) is detected or indicate that the IAB child node or the terminal equipment initiates a connection reestablishment in a case where an IAB node where the IAB child node or the terminal equipment is present performs an inter-centralized unit (inter-CU) recovery or migration; and
a processing portion configured to initiate a radio link failure recovery process or a connection reestablishment process.

According to a further aspect of the embodiments of this disclosure, there is provided an integrated access and backhaul (IAB) communication method, including:
receiving, by an IAB child node or terminal equipment, indication information transmitted by a network device, the indication information being used to indicate configuration information of a target-centralized unit (CU) to which the IAB child node or the terminal equipment corresponds in a case where an IAB node where the IAB child node or the terminal equipment is present performs an inter-centralized unit (inter-CU) recovery or migration; and
communicating, by the IAB child node or the terminal equipment, according to the configuration information of the target-centralized unit (CU).

According to a further aspect of the embodiments of this disclosure, there is provided an integrated access and backhaul (IAB) communication apparatus, including:
a receiving portion configured to receive indication information transmitted by a network device, the indication information being used to indicate configuration information of a target-centralized unit (CU) to which an IAB child node or terminal equipment corresponds in a case where an IAB node where the IAB child node or the terminal equipment is present performs an inter-centralized unit (inter-CU) recovery or migration; and
a processing portion configured to perform communication according to the configuration information of the target-centralized unit (CU).

One of the advantageous effects of the embodiments of this disclosure is that the IAB child node or the terminal equipment receives the indication information transmitted by the network device, and initiates the radio link failure recovery process or the connection reestablishment process according to the indication information; or the IAB child node or the terminal equipment receives the indication information transmitted by the network device, the indication information being used to indicate the configuration information of the corresponding target-centralized unit (CU), and performs communications according to the configuration information of the target CU. Therefore, in a case where the inter-CU recovery or handover is supported, even if the IAB child node or the terminal equipment does not change the serving IAB node, the IAB child node or the terminal equipment may also update the configuration information of the CU, and thus can correctly communicate with the target CU.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiments.

FIG. 1 is a schematic diagram illustrating a communication system according to an embodiment of this disclosure;

FIG. 2 is a schematic diagram illustrating an overall architecture of an IAB according to an embodiment of this disclosure;

FIG. 3 is another schematic diagram illustrating an overall architecture of an IAB according to an embodiment of this disclosure;

FIG. 4 is a schematic diagram illustrating a relationship between a child node and a parent node in an IAB network according to an embodiment of this disclosure;

FIG. 5 is a schematic diagram illustrating a protocol stack of a F1-U interface between an IAB-DU and an IAB-donor-CU;

FIG. 6 is a schematic diagram illustrating a protocol stack of a F1-C interface between an IAB-DU and an IAB-donor-CU;

FIG. 7 is a schematic diagram illustrating a protocol stack of a SRB between an IAB-MT and an IAB-donor-CU according to an embodiment of this disclosure;

FIG. 8 is a schematic diagram illustrating a CHO process of an Inter-CU of an IAB node;

FIG. 9 is a schematic diagram illustrating a RLF recovery process of an Inter-CU of an IAB node;

FIG. 10 is a schematic diagram illustrating an inter-CU handover or recovery scenario according to an embodiment of this disclosure;

FIG. 11 is a schematic diagram illustrating an IAB communication method according to an embodiment of this disclosure;

FIG. 12 is another schematic diagram illustrating the IAB communication method according to an embodiment of this disclosure;

FIG. 13 is another schematic diagram illustrating the IAB communication method according to an embodiment of this disclosure;

FIG. 14 is another schematic diagram illustrating the IAB communication method according to an embodiment of this disclosure;

FIG. 15 is another schematic diagram illustrating the IAB communication method according to an embodiment of this disclosure;

FIG. 16 is another schematic diagram illustrating the IAB communication method according to an embodiment of this disclosure;

FIG. 17 is another schematic diagram illustrating the IAB communication method according to an embodiment of this disclosure;

FIG. 18 is another schematic diagram illustrating the IAB communication method according to an embodiment of this disclosure;

FIG. 19 is another schematic diagram illustrating the IAB communication method according to an embodiment of this disclosure;

FIG. 20 is a schematic diagram illustrating a scenario of an IAB communication method according to an embodiment of this disclosure;

FIG. 21 is a schematic diagram illustrating an IAB communication apparatus according to an embodiment of this disclosure;

FIG. 22 is another schematic diagram illustrating the IAB communication apparatus according to an embodiment of this disclosure;

FIG. 23 is a schematic diagram illustrating a network device according to an embodiment of this disclosure; and

FIG. 24 is a schematic diagram illustrating terminal equipment according to an embodiment of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and New Radio (NR) in the future, etc., and/or other communication protocols that are currently known or will be developed in the future.

In the embodiments of this disclosure, the term “network device”, for example, refers to a device in a communication system that accesses terminal equipment to the communication network and provides services for the terminal equipment. The network device may include but not limited to the following devices: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.), an integrated access and backhaul (IAB) node, or an IAB-DU or an IAB-donor. The term “base station” may include some or all of its functions, and each base station may provide communication coverage for a specific geographical area. And a term “cell” may refer to a base station and/or its coverage area, depending on a context of the term. In the absence of confusion, the terms “cell” and “base station” are interchangeable.

In the embodiments of this disclosure, the term “user equipment (UE)” or “terminal equipment (TE) or terminal device” refers to, for example, equipment accessing to a communication network and receiving network services via a network device. The terminal equipment may be fixed or mobile, and may also be referred to as a mobile station (MS), a terminal, a subscriber station (SS), an access terminal (AT), and a station, etc.

The terminal equipment may include but not limited to the following devices: a cellular phone, a personal digital assistant (PDA), a wireless modem, a wireless communication device, a handheld device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above. “A device” in this text may refer to a network device, and may also refer to terminal equipment, except otherwise specified.

A scenario of an embodiment in this disclosure shall be described below by way of examples; however, this disclosure is not limited thereto.

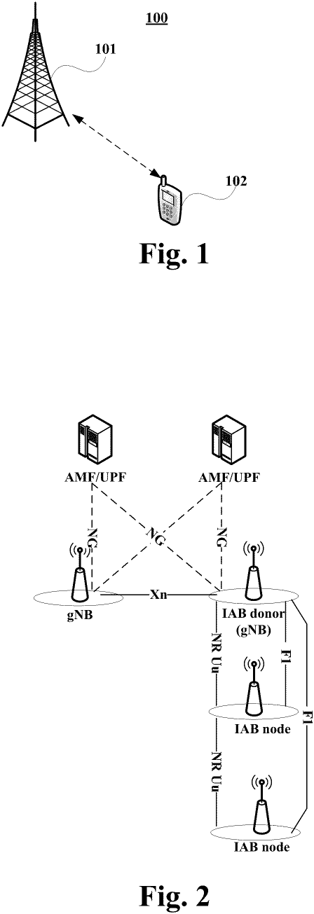

FIG. 1 is a schematic diagram illustrating a communication system according to an embodiment of this disclosure, which schematically illustrates a situation in which terminal equipment and a network device are used as an example. As shown in FIG. 1, a communication system 100 may include a network device 101 and terminal equipment 102. For simplicity, FIG. 1 only illustrates terminal equipment and a network device as an example, however, this disclosure is not limited thereto. For example, there may be a plurality of terminal equipment.

In an embodiment of this disclosure, existing services or services that can be implemented in the future may be transmitted between the network device 101 and the terminal equipment 102. For example, these services may include but are not limited to: an enhanced Mobile Broadband (eMBB), a massive Machine Type Communication (mMTC) and an Ultra-Reliable and Low-Latency Communication (URLLC), or the like.

A scenario of an embodiment in this disclosure shall be described below by way of examples; however, this disclosure is not limited thereto.

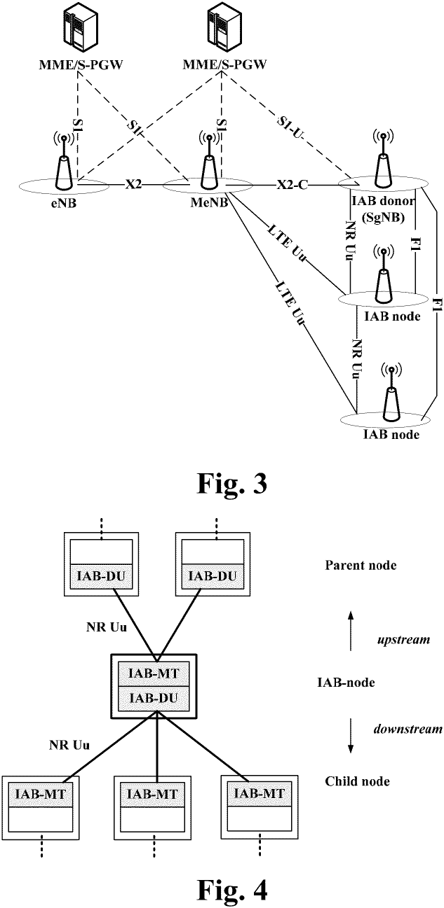

FIG. 2 is a schematic diagram illustrating an overall architecture of an IAB according to an embodiment of this disclosure. As shown in FIG. 2, a standalone mode is used in the overall architecture of the IAB. FIG. 3 is another schematic diagram illustrating the overall architecture of the IAB according to an embodiment of this disclosure. As shown in FIG. 3, a dual-connection (EN-DC) mode is used in the overall architecture of the IAB. In the dual-connection mode, an IAB node is connected to a MeNB via an E-UTRA and an IAB donor serves as a SgNB to terminate an X2-C.

FIG. 4 is a schematic diagram illustrating a relationship between a child node and a parent node in an IAB network according to an embodiment of this disclosure. As shown in FIG. 4, a direction from the IAB node to the child node is further referred to as downstream, whereas a direction to the parent node is referred to as upstream.

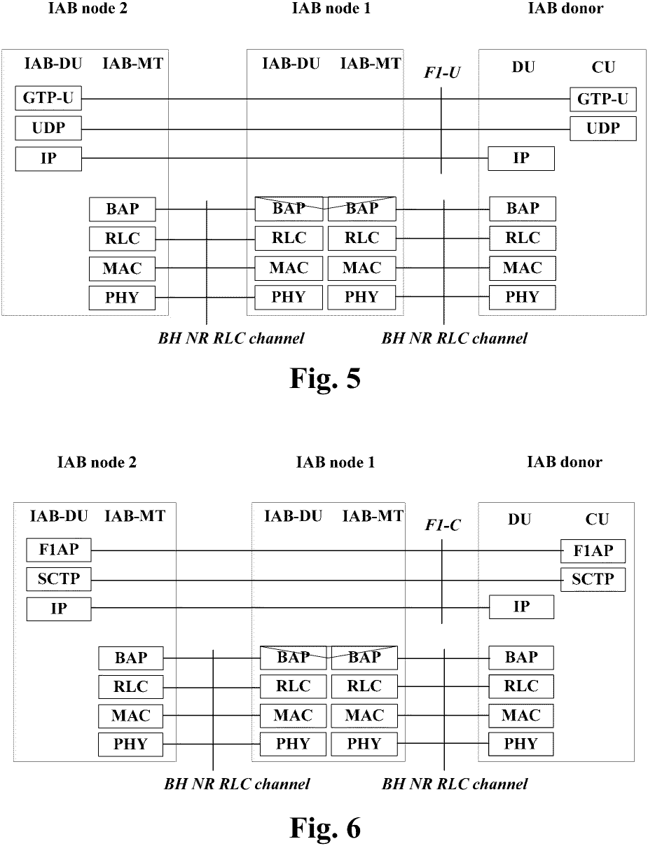

FIG. 5 is a schematic diagram illustrating a protocol stack of a F1-U interface between an IAB-DU and an IAB-donor-CU. FIG. 6 is a schematic diagram illustrating a protocol stack of a F1-C interface between an IAB-DU and an IAB-donor-CU. In FIG. and FIG. 6, the F1-U and the F1-C are illustrated using a 2-hop backhaul as an example. The F1-U and the F1-C use an IP transport layer between the IAB-DU and the IAB-donor-CU. In addition, the F1-U and the F1-C have security protection.

In an embodiment of this disclosure, in order to support data transmission and routing in the IAB network, a Backhaul Adaptation Protocol (BAP) layer is introduced. In the IAB node, a BAP sublayer includes a BAP entity located in a MT function and another co-located BAP entity located in a DU function. An IP layer performs a wireless backhaul via the BAP sublayer to ensure a multi-hop routing. The IP layer can also be used for a non-F1 service, such as an Operation Administration and Maintenance (OAM) service.

In an embodiment of this disclosure, on each backhaul link, BAP PDUs are transmitted on a BH Radio Link Control (RLC) channel; on each BH link, a plurality of BH RLC channels can be configured, which allows for traffic prioritization and Quality of Service (QoS) enforcement. The BAP entity on each IAB node and the IAB-donor-DU performs mappings of the BH RLC channels of the BAP PDUs.

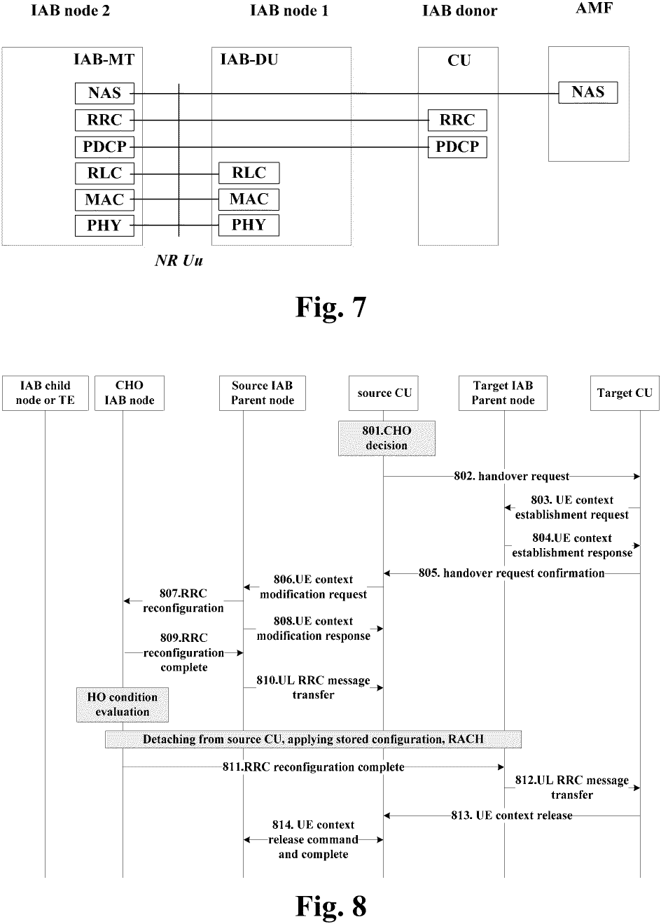

FIG. 7 is a schematic diagram illustrating a protocol stack of a signaling radio bearer (SRB) between an IAB-MT and an IAB-donor-CU according to an embodiment of this disclosure. The IAB-MT and the IAB-donor-CU establish the SRBs for carrying a RRC and a NAS. As shown in FIG. 7, the RRC layer and the Packet Data Convergence Protocol (PDCP) layer of the IAB child node (for example, the IAB-MT of the IAB node 2) or the terminal equipment at an opposite side (network side) are located on the CU.

The IAB network is schematically described above, and the recovery and handover are schematically described below.

In a normal handover (HO) process, the terminal equipment transmits a measurement report message to the network. If the network device determines that the terminal equipment needs to be handed over, the network device transmits relevant configuration of a target cell by using a RRC reconfiguration message (carrying the reconfiguration with sync) to the terminal equipment. When receiving the RRC reconfiguration message, the terminal equipment starts to perform the handover process. The handover may fail, since the measurement report transmitted by the terminal equipment may not be correctly received by the network device, or the RRC reconfiguration message transmitted by the network device may not be correctly received by the terminal equipment.

In Rel-16, a conditional handover (CHO) is introduced to improve handover reliability and reduce handover failures. In the CHO, the network device configures the terminal equipment with one or more candidate target cells (such as SpCell) in a conditional reconfiguration. The terminal equipment evaluates conditions corresponding to each configured candidate target cell. If a condition (i.e., a measurement event) corresponding to a target candidate cell is satisfied, the terminal equipment initiates a conditional handover to this cell and applies conditional reconfiguration related to this cell. 3GPP has agreed to use Rel-16CHO as a baseline in the IAB.

FIG. 8 is a schematic diagram illustrating a CHO process of an Inter-CU of an IAB node. As shown by 801 to 810 in FIG. 8, a source CU (or a source donor CU) decides to perform a CHO configuration on the IAB node (801), after which the source CU transmits a handover request message to one or more target CUs (or target donor CUs) (802).

If the target CU decides to accept migration of the IAB node, a UE context establishment process is performed between the target CU and a target IAB parent node (803 and 804) to prepare for relevant configurations and/or resources in the target IAB parent node for the IAB node. The target CU then transmits a handover request confirmation message to the source CU (805), where the handover request confirmation message carries the conditional reconfiguration of the target cell.

After the source CU receives the handover request confirmation message from one or more target CUs, the source CU transmits a RRC reconfiguration message to the IAB node via a source IAB parent node (807), wherein configuration(s) of one or more target cells and corresponding conditions are included. The IAB node receives and stores the RRC reconfiguration message and replies with a RRC reconfiguration complete message (809).

The IAB node evaluates conditions according to the configuration(s) of one or more target cells and the corresponding conditions included in the RRC reconfiguration message. When the conditions are considered to be satisfied, detaching from the source CU and the stored configuration of the target cell that satisfies the conditions can be applied, and a random access to the target cell can be initiated via a random access channel (RACH).

As shown by 811 to 812 in FIG. 8, the IAB node may perform the CHO. After the IAB node is successfully migrated to the target CU, the target CU may notify the source CU to release the context of the IAB node, as shown by 813 to 814 in FIG. 8.

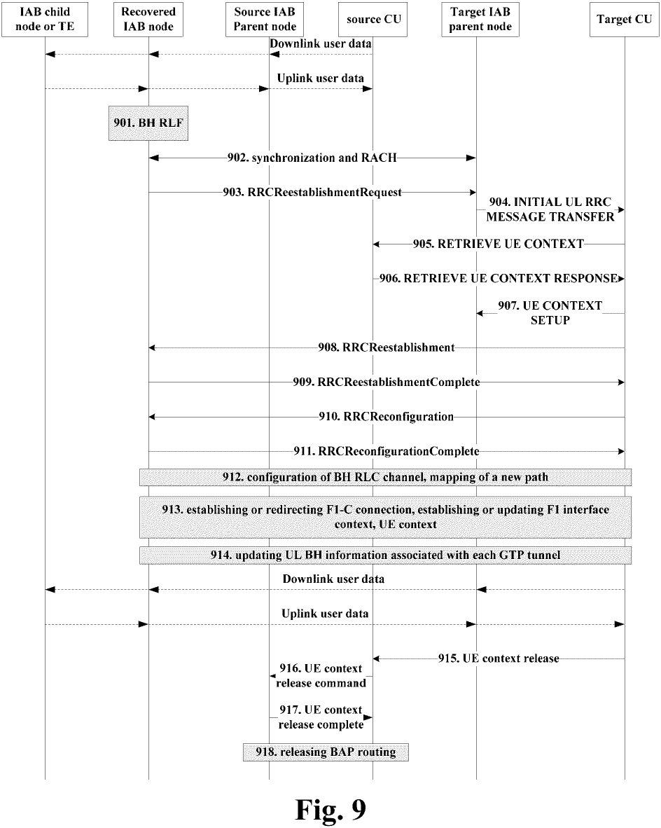

In Rel-16, the IAB node may also perform a Radio Link Failure (RLF) recovery of the Inter-CU. FIG. 9 is a schematic diagram illustrating a RLF recovery process of an Inter-CU of an IAB node. In FIG. 9, some entities are omitted for simplicity. For example, the source IAB parent node may include at least one of an initial parent IAB node, an intermediate hop IAB node on an initial path, and an initial IAB-donor-DU, and the target IAB parent node may include at least one of a new parent IAB node, an intermediate hop IAB node on a new path, and a new IAB-donor-DU.

As shown in FIG. 9, the inter-CU RLF recovery process of the IAB node may include:
901: the IAB node (IAB-MT) detects the RLF of backhaul (BH);
902: the IAB MT performs synchronization and RACH to the target IAB parent node (also known as a new IAB parent node) served by the target IAB-donor CU (also known as a new IAB-donor CU);
903-904: the recovered IAB MT transmits a RRC reestablishment request message to the target IAB-donor CU via the target IAB parent node;
905-906: the target IAB-donor CU acquires a UE context of the IAB MT from the source IAB-donor CU (also called an old IAB-donor CU) via an Xn interface;
907: the target IAB-donor CU initiates the UE context establishment process to the target IAB parent node to establish an F1 logical connection to the recovered IAB-MT;
908: the target IAB-donor CU transmits a RRC reestablishment message to the IAB-MT via the target IAB parent node;
909: the recovered IAB MT transmits a RRC reestablishment complete message to the target IAB-donor CU via the target IAB parent node;
910-911: the target IAB-donor CU transmits the RRC reconfiguration message to the recovered IAB-MT via the target IAB parent node, and the recovered IAB-MT responds to the RRC reconfiguration complete message;
912: the IAB-donor CU configures BH RLC channels and BAP sublayer routing entries on a new path between the target IAB parent node and the target IAB-donor DU, and DL mappings of the new path of the recovered IAB node on the target IAB-donor DU;
913: the DU of the recovered IAB node establishes or redirects the F1-C connection with the target CU, and establishes or updates an F1 interface context, a UE context, or the like;
914: the IAB-donor CU updates the F1-U connection to the recovered IAB node, e.g., updates the UL BH information associated with each GTP tunnel;
915: the target IAB-donor CU transmits a UE context release message to instruct the source IAB-donor CU to release resources of the recovered IAB node;
916: the source IAB-donor CU transmits a UE context release complete message to the source IAB parent node;
917: the source IAB parent node releases the recovered IAB-MT context and responds to the UE context release complete message; and
918: the source IAB-donor CU releases the BH RLC channels and routing entries of the BAP sublayer on the source path between the source IAB parent node and the source IAB-donor DU.

The Inter-CU CHO and RLF recovery performed on the IAB node are schematically illustrated, however, this disclosure is not limited thereto. The related technologies may also be referred to for the content of handover or recovery.

In the Rel-16, only an intra-CU RLF recovery or an intra-CU CHO is supported, where the IAB node is still connected to a pre-migrated IAB donor CU (hereinafter referred to as CU) after the RLF recovery or the CHO is performed. In this case, the IAB child node or the terminal equipment can perform communication with the CU along a path of the IAB node after the recovery or the CHO. Since the CU has not changed, that is, the RRC layer and the PDCP layer of the IAB child node or the terminal equipment at an opposite side (network side) are not changed, the problem that the configuration information of the CU is changed and the IAB child node or the terminal equipment cannot obtain the configuration information does not exist, for example, updated security keys or other security parameters can be transmitted by the CU via the recovered or the CHOed IAB node to the IAB child node or the terminal equipment.

In Rel-17, the inter-CU RLF recovery or the inter-CU CHO is supported.

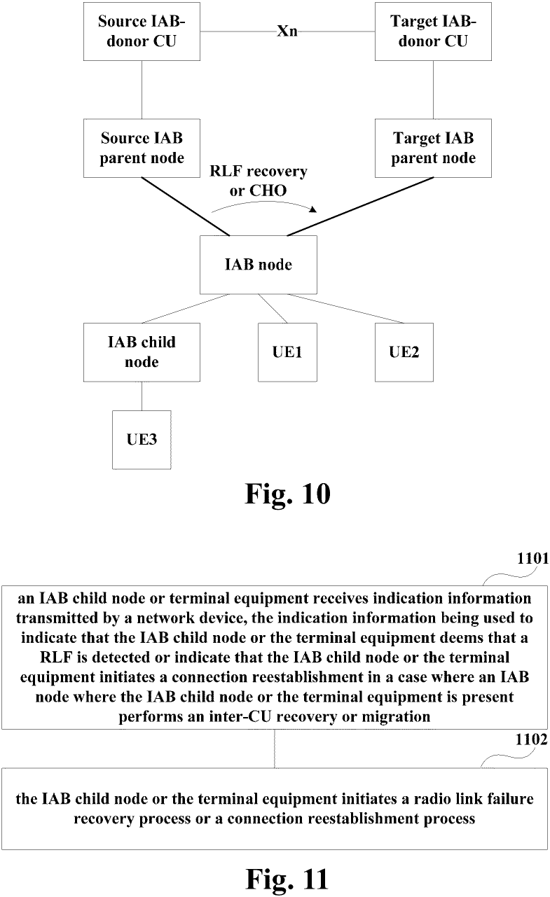

FIG. 10 is an example diagram illustrating an inter-CU handover or recovery scenario according to an embodiment of this disclosure. As shown in FIG. 10, when the IAB node performing recovery or the CHO to the target IAB-donor CU, physical cell identity (PCI) and frequency of the cell provided by the DU of the IAB node may remain unchanged. If the IAB child node or the terminal equipment of the IAB node is still under the coverage of an original cell, the topology relationship may remain unchanged, and the IAB child node or the terminal equipment is migrated to the target CU along with the IAB node.

It is assumed that the IAB child node or the terminal equipment is migrated to the target IAB-donor CU (hereinafter referred to as the target CU) along with the IAB node performing the recovery or the CHO, since the corresponding RRC and PDCP layers are located in the target CU, the target CU adopts configuration information different from the source CU as the target CU is a gNB device different from the source CU, such as security parameters (such as keys) and/or security algorithms, so the child node or the terminal equipment needs to update the configuration information of the target CU.

However, since the IAB child node or the terminal equipment does not change the serving IAB node, the IAB child node or the terminal equipment may not initiate the reestablishment process to obtain the configuration information of the target CU, and also cannot correctly receive the configuration information transmitted by the target CU by using the configuration of the target CU (such as security parameters and/or security algorithms), therefore, the configuration information of the target CU is not updated, which results in that it cannot correctly communicate with the target CU.

In view of the above problem, the embodiments of this disclosure are further described below. In the embodiments of this disclosure, “when......”, “in a case where......”, “in a case of......” and “if.......” indicate that based on one or some conditions or states, these expressions are interchangeable. In addition, “indication” may explicitly include certain information for notification, or implicitly include notification through certain features, etc.

### Embodiments of a First Aspect

The embodiments of this disclosure provide an IAB communication method described from an IAB child node or terminal equipment. FIG. 11 is a schematic diagram illustrating an IAB communication method according to an embodiment of this disclosure. As shown in FIG. 11, the method includes:
1101: an IAB child node or terminal equipment receives indication information transmitted by a network device, the indication information being used to indicate that the IAB child node or the terminal equipment deems that a radio link failure (RLF) is detected or indicate that the IAB child node or the terminal equipment initiates a connection reestablishment in a case where an IAB node where the IAB child node or the terminal equipment is present performs an inter-centralized unit (inter-CU) recovery or migration; and
1102: the IAB child node or the terminal equipment initiates a radio link failure recovery process or a connection reestablishment process.

It should be noted that FIG. 11 only schematically illustrates the embodiments of this disclosure, however, this disclosure is not limited thereto. For example, an order of execution of the operations may be appropriately adjusted, and furthermore, some other operations may be added, or some operations therein may be reduced. And appropriate variants may be made by those skilled in the art according to the above contents, without being limited to what is contained in FIG. 11.

Therefore, the IAB child node or the terminal equipment initiates the radio link failure recovery process or the connection reestablishment process, and can obtain configuration information of the target CU. The IAB child node or the terminal equipment can update the configuration information of the target CU, thus can correctly communicate with the target CU. For the specific disclosure of the radio link failure recovery process or the connection reestablishment process, reference may be made to the embodiments described later, and also to related technologies, for example, FIG. 8 and FIG. 9.

In some embodiments, the indication information is first indication information transmitted by an IAB node of an inter-centralized unit (inter-CU) performing a radio link failure (RLF) recovery or a conditional handover (CHO) migration.

FIG. 12 is a schematic diagram illustrating an IAB communication method according to an embodiment of this disclosure. As shown in FIG. 12, the IAB node during or after the RLF recovery or CHO process can transmit first indication information to the affiliated IAB child node or terminal equipment; after the IAB child node or the terminal equipment receives the first indication information, the IAB child node or the terminal equipment deems that a radio link failure (RLF) is detected or a connection reestablishment process is initiated.

In some embodiments, in a process in which an inter-centralized unit (inter-CU) performs a radio link failure (RLF) recovery, in a case where the IAB node receives a radio resource control reestablishment (RRC reestablishment) message transmitted by a target centralized unit (target CU), or establishes an F1 interface with the target CU, or receives backhaul (BH) configuration information, the IAB node transmits the first indication information to the IAB child node or the terminal equipment. In an embodiment, the target CU is a donor CU where a cell in which the IAB node performs the RLF recovery is located, such as a donor CU where a cell selected by the IAB node during the RRC connection reestablishment process is located.

For example, a moment when the IAB node transmits the first indication information may be any time point from 907 to 915 in FIG. 9, such as, a moment when the recovered IAB-MT transmits the RRC reestablishment request message, or a moment when the recovered IAB-MT receives the RRC reestablishment message, or a moment when the recovered IAB-MT transmits the RRC reestablishment complete message, or a moment when the MT of the recovered IAB-node receives the first RRC reconfiguration message after reestablishing the RRC connection, or a moment when the MT of the recovered IAB-node transmits the radio resource control reconfiguration complete (RRC reconfiguration complete) message, or a moment when the DU of the recovered IAB-node transmits an F1AP setup request message to the target CU, or a moment when the F1 setup response message is received from the target CU, or when a SCTP connection between the target CU and the recovered IAB-node is established, or a moment when the F1-C connection is handed over to use a new TNL address of the recovered IAB-node and a new TNL address of the IAB-donor CU,

or a moment when the target CU and the recovered IAB-DU establish or reestablish or update the F1 interface context, such as a moment when the gNB DU configures a update process or the gNB CU configures a update process; or a moment when the target CU and the recovered IAB-DU establish or reestablish or update the F 1AP UE context of the child IAB node or the UE of the recovered IAB-node; or a moment when the DU of the recovered IAB node receives BH configuration information, where the BH configuration information can include, for example, BH RLC channels and BAP sublayer routing entries on a new path between the target IAB parent node and the target IAB donor DU, or DL mappings of the new path of the recovered IAB node on the target IAB donor DU; or a moment when F1-U connection (such as GTP tunnel information) is updated, or the like.

In some embodiments, after the inter-centralized unit (inter-CU) performs the radio link failure (RLF) recovery process, the IAB node transmits the first indication information to the IAB child node or the terminal equipment. In an embodiment, the target CU is the donor CU where the cell in which the IAB node performs the RLF recovery is located, such as, the donor CU where the cell selected by the IAB node for the RRC connection reestablishment process is located.

In some embodiments, in a case where the IAB child node or the terminal equipment is configured with single connectivity, or in a case where the IAB child node or the terminal equipment is configured with dual connectivity and the IAB node is a master cell group (MCG) of the IAB child node or the terminal equipment, the IAB child node or the terminal equipment deems (determines) that the radio link failure (RLF) is detected for the MCG.

For example, the IAB child node or the terminal equipment initiates the radio link failure recovery process, includes: in a case where the IAB child node has been activated on access stratum security (AS security) and the SRB2 has been established, or in a case where the terminal equipment has been activated on access stratum security (AS security) and the SRB2 and at least one data radio bearer (DRB) have been established, in a case where a timer (T316) is configured, and a SCG transmission is not suspended, and a primary serving cell change (PSCell change) is not in progress, the IAB child node or the terminal equipment initiates a MCG failure information process to report a MCG radio link failure, otherwise initiates the connection reestablishment process.

In some embodiments, in a case where the IAB child node or the terminal equipment is configured with dual connectivity and the IAB node is a secondary cell group (SCG) of the IAB child node or the terminal equipment, the IAB child node or the terminal equipment deems (determines) that the radio link failure (RLF) is detected for the SCG.

For example, the IAB child node or the terminal equipment initiates the radio link failure recovery process, includes: in a case where the MCG transmission is not suspended, the IAB child node or the terminal equipment initiates a SCG failure information process to report a SCG radio link failure, otherwise initiates the connection reestablishment process.

In some embodiments, in a case where the IAB child node or the terminal equipment is configured with CHO, the IAB child node or the terminal equipment may initiate the CHO process.

In some embodiments, in a process in which the inter-centralized unit (inter-CU) performs the conditional handover (CHO) migration, in a case where the IAB node initiates the conditional handover (CHO), or transmits a radio resource control reconfiguration complete (RRC reconfiguration complete) message, or establishes an F1 interface with the target CU, or receives BH configuration information, the IAB node transmits the first indication information to the IAB child node or the terminal equipment.

For example, a moment when the IAB node transmits the first indication information may be any time point from the HO condition evaluation to 811 in FIG. 8, such as, a moment when the IAB node initiates the CHO (for example, detaches from source or starts to apply the stored conditional reconfiguration of the target cell that satisfies conditions or starts to initiate RACH to the target cell), or a moment when the RRC reconfiguration complete message is transmitted, or a moment when a RLC layer confirmation or a HARQ confirmation of the RLC reconfiguration complete message is received, or a moment when a DU of the IAB node transmits a F1AP setup request message to the target CU, or a moment when the F1 setup response message is received from the target CU, or a moment when a SCTP connection between the target CU and the IAB node is established, or a moment when a F1-C connection is handed over to use a new TNL address of the IAB node and a TNL address of the target CU,

or a moment when the target CU and the IAB-DU establish or reestablish or update a F1 interface context, such as, a moment when the gNB DU configures a update process or the gNB CU configures a update process; or a moment when the target CU and the DU of the IAB node establish or reestablish or update the F1AP UE context of the child IAB node or the UE of the recovered IAB node; or a moment when the DU of the IAB node receives BH configuration information, where the BH configuration information may include, for example, BH RLC channels and BAP sublayer routing entries on a new path between the target IAB parent node and the target IAB-donor DU, or DL mappings of the new path of the IAB node on the target IAB-donor DU; or a moment when F1-U connection (such as GTP tunnel information) is updated, or the like.

In some embodiments, after the inter-centralized unit (inter-CU) performs the conditional handover (CHO) migration process, the IAB node transmits the first indication information to the IAB child node or the terminal equipment.

In some embodiments, the first indication information includes at least one or any combination of: a backhaul adaptation protocol (BAP) protocol data unit (PDU), a radio link control (RLC) PDU, a medium access control (MAC) control element (CE), a medium access control (MAC) subheader, or physical layer signaling.

For example, a new BAP control PDU may be defined, or a BH RLF indication, such as a BAP control PDU of type 3 BH RLF indication, may be used, or a new RLC control PDU may be defined. For the content of the BH RLF indication, reference may also be made to Embodiments of a third aspect described later.

For another example, a new MAC CE may be defined, and the MAC CE corresponds to a new LCID in a subheader; or a new MAC subheader may be defined, and a new LCID is used in the MAC subheader.

For another example, a field in the DCI may be used, a group common DCI, a common DCI, a UE-specific DCI, or a Paging-DCI may be used, and the field may be 1 bit.

In some embodiments, the first indication information may also indicate whether the donor CU of the IAB node has changed, or indicate that the IAB node has performed an intra-CU migration or an inter-CU migration.

In some embodiments, the first indication information includes at least one of: an indication of change in CU, an identifier of the target CU, an indication of initiating a reestablishment process, or the like.

The description is given by using the IAB node transmitting the first indication information as an example, and the source CU transmitting the third indication information is described below.

In some embodiments, the indication information is the third indication information transmitted via the recovered or migrated path by the source centralized unit (source CU) of the inter-centralized unit (inter-CU) performing the radio link failure (RLF) recovery or the conditional handover (CHO) migration.

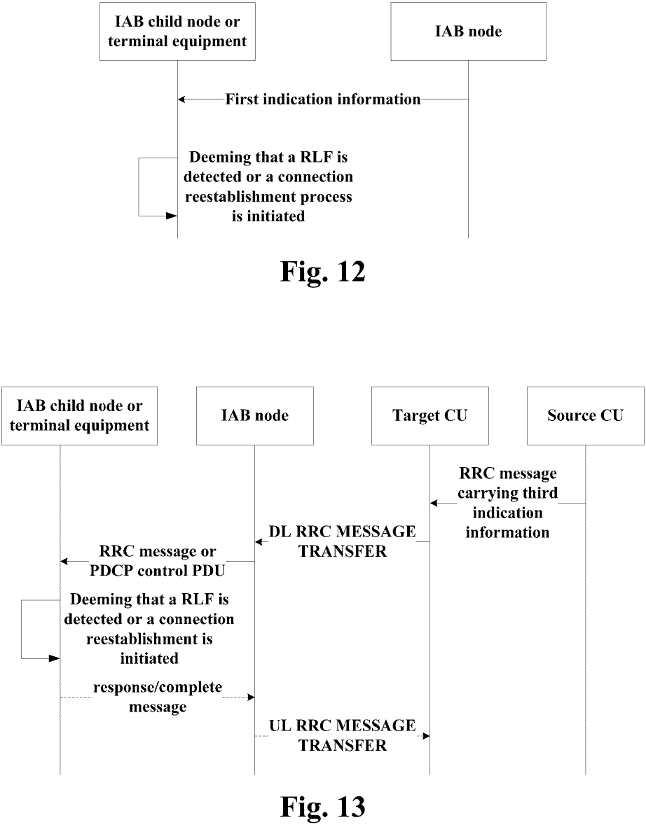

FIG. 13 is another schematic diagram illustrating an IAB communication method according to an embodiment of this disclosure. As shown in FIG. 13, the source CU may transmit the third indication information to the IAB child node or the terminal equipment; after the IAB child node or the terminal equipment receives the third indication information, the IAB child node or the terminal equipment deems that the radio link failure (RLF) is detected or the connection reestablishment process is initiated.

In some embodiments, the source centralized unit (CU) transmits the third indication information to the target CU or a distributed unit (DU) of the IAB node via an Xn interface, and the target CU or the DU transmits the third indication information to the IAB child node or the terminal equipment.

For example, as shown in FIG. 13, the source CU can transmit the RRC message carrying the third indication information to the target IAB-donor CU via an Xn interface, and the target IAB-donor CU transmits the third indication information to the handed over or recovered IAB node by using DL RRC MESSAGE TRANSFER, the IAB node transmits the third indication information to the IAB child node or the terminal equipment by using the RRC message or the PDCP control PDU.

As shown in FIG. 13, the IAB child node or the terminal equipment may deem that the radio link failure (RLF) is detected or the connection reestablishment process is initiated. In addition, the IAB child node or the terminal equipment may also transmit a response message or a completion message to the handed over or recovered IAB node (optional), the IAB node may also transmit information to the target IAB-donor CU by using UL RRC MESSAGE TRANSFER (optional).

In some embodiments, in a process in which the inter-centralized unit (inter-CU) performs the radio link failure (RLF) recovery, in a case where the source CU receives a retrieval context request message transmitted by the target CU, or in a case where the source CU transmits a retrieval context response message to the target CU, or in a case where the source CU receives a context release message transmitted by the target CU, the source CU transmits the third indication information.

For example, for the inter-CU RLF recovery, a moment when the source CU transmits the third indication information may be any of time points: for example, a moment when the source CU receives the Retrieve UE context request message transmitted by the target IAB-donor CU via an Xn interface, or a moment when the Retrieve UE context response message is transmitted to the target IAB-donor CU via an Xn interface, or a moment when the UE context release message transmitted by the target IAB-donor CU is received or after that.

For another example, for the inter-CU RLF recovery scenario, the moment when the third indication information is transmitted includes: a moment when the recovered IAB-MT transmits the RRC reestablishment request message, or a moment when the recovered IAB-MT receives the RRC reestablishment message, or a moment when the recovered IAB-MT transmits the RRC reestablishment complete message, or a moment when the MT of the recovered IAB node receives the first RRC reconfiguration message after reestablishing the RRC connection, or a moment when the MT of the recovered IAB node transmits the RRC reconfiguration complete message, or a moment when the DU of the recovered IAB node transmits the FlAP setup request message to the target CU, or a moment when the F1 setup response message is received from the target CU, or a moment when the SCTP connection between the target CU and the recovered IAB node is established, or a moment when the F1-C connection is handed over to use the new TNL address of the recovered IAB node and the new TNL address of the IAB-donor CU,

or a moment when the target CU and the recovered IAB-DU establish or reestablish or update the F1 interface context, such as a moment when the gNB DU configures the update process or the gNB CU configures the update process; or a moment when the target CU and the recovered IAB-DU establish or reestablish or update the FlAP UE context of the child IAB node or the UE of the recovered IAB node; or a moment when the DU of the recovered IAB node receives BH configuration information, where the BH configuration information may include, for example, BH RLC channels and BAP sublayer routing entries on a new path between the target IAB parent node and the target IAB-donor DU, or DL mappings of the new path of the recovered IAB node on the target IAB-donor DU; or a moment when F1-U connection (such as GTP tunnel information) is updated, or the like.

In some embodiments, after the inter-centralized unit (inter-CU) performs the radio link failure (RLF) recovery process, the source CU transmits the third indication information.

In some embodiments, in a case where the IAB child node or the terminal equipment is configured with single connectivity, or in a case where the IAB child node or the terminal equipment is configured with dual connectivity and the IAB node is a master cell group (MCG) of the IAB child node or the terminal equipment, the IAB child node or the terminal equipment deems (determines) that the radio link failure (RLF) is detected for the MCG.

For example, initiating, by the IAB child node or the terminal equipment, a radio link failure recovery process, includes: in a case where the IAB child node has been activated on access stratum security (AS security) and the SRB2 has been established, or in a case where the terminal equipment has been activated on the access stratum security (AS security) and the SRB2 and at least one data radio bearer (DRB) have been established, in a case where the timer (T316) is configured, the SCG transmission is not suspended, and the primary serving cell change (PSCell change) is not in progress, the IAB child node or the terminal equipment initiates the MCG failure information process to report the MCG radio link failure, otherwise initiates the connection reestablishment process.

In some embodiments, in a case where the IAB child node or the terminal equipment is configured with dual connectivity and the IAB node is a secondary cell group (SCG) of the IAB child node or the terminal equipment, the IAB child node or the terminal equipment deems (determines) that the radio link failure (RLF) is detected for the SCG.

For example, initiating, by the IAB child node or the terminal equipment, the radio link failure recovery process, includes: in a case where the MCG transmission is not suspended, the IAB child node or the terminal equipment initiates the SCG failure information process to report the SCG radio link failure, otherwise initiates the connection reestablishment process.

In some embodiments, in a process in which the inter-centralized unit (inter-CU) performs the conditional handover (CHO) migration, the source CU transmits the third indication in the case of receiving a context release message transmitted by the target CU.

For example, for the inter-CU CHO, a moment when the source CU transmits the third indication information may be any of time points: in 813 in FIG. 8, a moment when the source CU receives the UE context release message transmitted by the target IAB-donor CU or after that.

For another example, for the inter-CU CHO scenario, the moment where the third indication information is transmitted includes: a moment when the IAB node initiates the CHO (for example, detaches from source or starts to apply the stored conditional reconfiguration of the target cell that satisfies conditions or starts to initiate RACH to the target cell), or a moment when the RRC reconfiguration complete message is transmitted, or a moment when a RLC layer confirmation or a HARQ confirmation of the RLC reconfiguration complete message is received, or a moment when the DU of the IAB-node transmits the FlAP setup request message to the target CU, or a moment when the F1 setup response message is received from the target CU, or a moment when the SCTP connection between the target CU and the IAB node is established, or a moment when the F1-C connection is handed over to use the new TNL address of the IAB node and the TNL address of the target CU,

or a moment when the target CU and the IAB-DU establish or reestablish or update the F1 interface context, such as a moment when the gNB DU configures the update process or the gNB CU configures the update process; or a moment when the target CU and the DU of the IAB node establish or reestablish or update the F1AP UE context of the child IAB node or the UE of the recovered IAB node; or a moment when the DU of the IAB node receives BH configuration information, where the BH configuration information may include, for example, BH RLC channels and BAP sublayer routing entries on a new path between the target IAB parent node and the target IAB-donor DU, or DL mappings of the new path of the IAB node on the target IAB-donor DU; or a moment when the F1-U connection (such as GTP tunnel information) is updated, or the like.

In some embodiments, after the inter-centralized unit (inter-CU) performs the conditional handover (CHO) migration process, the source CU transmits the third indication information.

In some embodiments, the third indication information includes at least one or any combination of: a packet data convergence protocol (PDCP) protocol data unit (PDU), a radio resource control (RRC) message, or an FlAP message.

For example, the third indication information may be included in the PDCP PDU (which carries the RRC message or the PDCP control PDU), and ciphering and/or integrity protection such as an old key and security algorithms are used. For another example, for the descendant IAB node, the third indication information may also be carried in the F1AP message and transmitted to the DU of the descendant IAB node.

In some embodiments, the third indication information may further indicate whether the donor CU of the IAB node has changed, or indicate that the IAB node has performed an intra-CU migration or an inter-CU migration.

In some embodiments, the third indication information includes at least one of: an indication of change in CU, an identifier of the target CU, an indication of initiating a reestablishment process, or the like.

In the embodiments of this disclosure, the descendant IAB-nodes or the UE may indicate its capability to the CU in order to demonstrate whether or not to support the communication method in the embodiment. In addition, the RRC message may be, for example, a RRC reestablishment message or a RRC reconfiguration message; the F1AP message may be a UE context setup request or a UE context modification request; and an Xn message may be a RRC transfer or a Retrieve UE context response.

In some embodiments, configuration information of the CU may include at least one or any combination of: configuration of the RRC layer, configuration of the PDCP layer, configuration of the RLC layer, configuration of the MAC layer, configuration of the physical layer, and configuration of the BAP layer.

It should be noted that FIG. 11 to FIG. 13 can be combined with FIG. 8 or FIG. 9, however, this disclosure is not limited thereto, and can also be combined with other inter-CU recovery or handover process. The embodiments of this disclosure are not limited to the specific steps or order of execution in these processes.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It can be known from the embodiments that the IAB child node or the terminal equipment receives the indication information transmitted by the network device, and initiates the radio link failure recovery process or the connection reestablishment process according to the indication information. Therefore, in a case where the inter-CU recovery or handover is supported, even if the IAB child node or the terminal equipment does not change the serving IAB node, the IAB child node or the terminal equipment may update the configuration information of the CU, thus can correctly communicate with the target CU.

### Embodiments of a Second Aspect

The embodiments of this disclosure provide an IAB communication method described from an IAB child node or terminal equipment, with the contents identical to those in the embodiments of the first aspect being not going to be described herein any further.

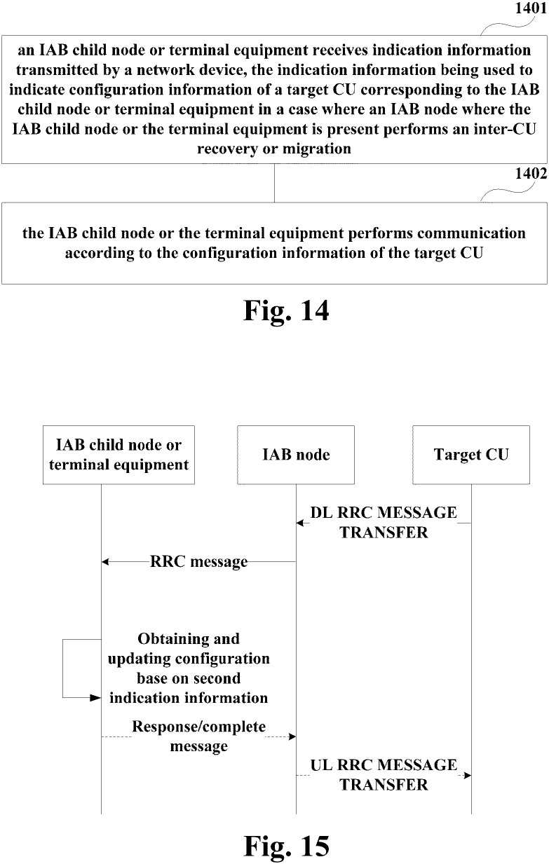

FIG. 14 is a schematic diagram illustrating an IAB communication method according to an embodiment of this disclosure. As shown in FIG. 14, the method includes:
1401: an IAB child node or terminal equipment receives indication information transmitted by a network device, the indication information being used to indicate configuration information of a target CU corresponding to the IAB child node or terminal equipment in a case where an IAB node where the IAB child node or the terminal equipment is present performs an inter-centralized unit (inter-CU) recovery or migration; and
1402: the IAB child node or the terminal equipment performs communication according to the configuration information of the target CU.

It should be noted that FIG. 14 only schematically illustrates the embodiment of this disclosure, however, this disclosure is not limited thereto. For example, an order of execution of the operations may be appropriately adjusted, and furthermore, some other operations may be added, or some operations therein may be reduced. And appropriate variants may be made by those skilled in the art according to the above contents, without being limited to what is contained in FIG. 14.

Therefore, the IAB child node or the terminal equipment receives the configuration information of the target CU transmitted by the network device, and the IAB child node or the terminal equipment can update the configuration information of the CU, so as to correctly communicate with the target CU.

In some embodiments, the configuration information of the target CU (i.e., the target donor CU) may include at least one or any combination of: configuration of a radio resource control (RRC) layer, configuration of a packet data convergence protocol (PDCP) layer, configuration of a RLC Layer, configuration of a MAC layer, configuration of a physical layer, or configuration of a BAP layer. The configuration information may include security-related configuration, such as security keys, security algorithms, and whether to apply security parameters of a master cell group or a secondary cell group.

In some embodiments, the indication information may be the same as the configuration information of the target CU, for example, the indication information directly includes the configuration information of the target CU. The indication information may also be different from the configuration information of the target CU, for example, the indication information may only indicate a sequence number or an index of the configuration information of the target CU, or the indication information may be a part of the configuration information of the target CU.

In some embodiments, the indication information is second indication information transmitted by the target CU of an inter-centralized unit (inter-CU) performing a radio link failure (RLF) recovery or a conditional handover (CHO) migration. For example, a context of the IAB child node or the terminal equipment of recovered or CHOed IAB node is transmitted by a source CU (such as, a source donor CU) to the target CU in advance via an Xn interface, e.g., transmitted together with the context of the IAB node. For example, in a case of the RLF recovery, a Retrieve UE Context Response message is transmitted by the source CU to the target CU, and in a case of the CHO, a Handover Request message is transmitted by the source CU to the target CU. Or a context of the descendant IAB node or UE of the recovered or migrated IAB node is transmitted separately, for example, after the IAB node is recovered or CHOed to the target CU, acquired by the target CU from the source CU (for example, after the RRC Reconfiguration complete message transmitted by the recovered or CHOed IAB node is received, or an F1 interface is established with the recovered or CHOed IAB node), or transmitted by the source CU to the target CU (for example, after receiving releasing the UE context release message of the recovered or CHOed IAB node). The target CU may transmit the second indication information to the IAB child node or the terminal equipment according to the context of the IAB child node or the terminal equipment.

In some embodiments, in a process in which the inter-centralized unit (inter-CU) performs the radio link failure (RLF) recovery, in a case where the target CU transmits a radio resource control reestablishment (RRC reestablishment) message or receives a radio resource control reestablishment complete (RRC reestablishment complete) message, or establishes an F1 interface with the IAB node, or transmits BH configuration information, the target CU transmits the second indication information to the IAB child node or the terminal equipment.

For example, for an inter-CU RLF recovery scenario, a moment when the target CU transmits the second indication information may be any time point from 907 to 915 in FIG. 9, such as a moment when the recovered IAB-MT transmits the RRC reestablishment request message, or a moment when the recovered IAB-MT receives the RRC reestablishment message, or a moment when the recovered IAB-MT transmits the RRC reestablishment complete message, or a moment when the MT of the recovered IAB node receives the RRC reconfiguration message after reestablishing the RRC connection, a moment when the MT of the recovered IAB node transmits the RRC reconfiguration complete message, or a moment when the DU of the recovered IAB node transmits the F1AP setup request message to the target CU, or a moment when the F1 setup response message is received from the target CU, or a moment when the SCTP connection between the target CU and the recovered IAB node is established, or a moment when the F1-C connection is handed over to use the new TNL address of the recovered IAB node and the new TNL address of the IAB-donor CU,

or a moment when the target CU and the recovered IAB-DU establish or reestablish or update the F1 interface context, such as a moment when the gNB DU configures the update process or the gNB CU configures the update process; or a moment when the target CU and the recovered IAB-DU establish or reestablish or update the FlAP UE context of the child IAB node or the UE of the recovered IAB node; or a moment when the DU of the recovered IAB node receives BH configuration information, where the BH configuration information may include, for example, BH RLC channels and BAP sublayer routing entries on a new path between the target IAB parent node and the target IAB-donor DU, or DL mappings of the new path of the recovered IAB node on the target IAB-donor DU; or a moment when F1-U connection (such as GTP tunnel information) is updated, or the like.

In some embodiments, after the inter-centralized unit (inter-CU) performs the radio link failure (RLF) recovery process, the target CU transmits the second indication information to the IAB child node or the terminal equipment.

In some embodiments, in a process in which the inter-centralized unit (inter-CU) performs the conditional handover (CHO) migration, in a case where the target CU receives a radio resource control reconfiguration complete message, or establishes an F1 interface with the IAB node, or transmits BH configuration information, the target CU transmits the second indication information to the IAB child node or the terminal equipment.

For example, for an inter-CU CHO scenario, a moment when the target CU transmits the second indication information may be any time point from the HO condition evaluation to 811 in FIG. 8, such as, a moment when the IAB node initiates the CHO (for example, detaches from source or starts to apply the stored conditional reconfiguration of the target cell that satisfies conditions or starts to initiate RACH to the target cell), or a moment when the RRC reconfiguration complete message is transmitted, or a moment when a RLC layer confirmation or a HARQ confirmation of the RLC reconfiguration complete message is received, or a moment when the DU of the IAB node transmits the FlAP setup request message to the target CU, or a moment when the F1 setup response message is received from the target CU, or a moment when the SCTP connection between the target CU and the IAB node is established, or a moment when the F1-C connection is handed over to use the new TNL address of the IAB node and the TNL address of the target CU,

or a moment when the target CU and the IAB-DU establish or reestablish or update the F1 interface context, such as a moment when the gNB DU configures the update process or the gNB CU configures the update process; or a moment when the target CU and the DU of the IAB node establish or reestablish or update the F1AP UE context of the child IAB node or the UE of the recovered IAB node; or a moment when the DU of the IAB node receives BH configuration information, where the BH configuration information may include, for example, BH RLC channels and BAP sublayer routing entries on a new path between the target IAB parent node and the target IAB-donor DU, or DL mappings of the new path of the IAB node on the target IAB-donor DU; or a moment when F1-U connection (such as GTP tunnel information) is updated, or the like.

In some embodiments, after the inter-centralized unit (inter-CU) performs the conditional handover (CHO) migration process, the target CU transmits the second indication information to the IAB child node or the terminal equipment.

In some embodiments, the second indication information indicates configuration information of a radio resource control (RRC) layer and/or a packet data convergence protocol (PDCP) layer in the target CU. For example, the second indication information includes at least one or any combination of: a next HopChainingCount, a keySet ChangeIndicator, non-access stratum (NAS) security information (NAS-Container), a ciphering Algorithm, or an integrityProtAlgorithm, however, this disclosure is not limited thereto.

In some embodiments, the second indication information may also indicate whether the donor CU of the IAB node has changed, or indicate that the IAB node has performed an intra-CU migration or an inter-CU migration.

In some embodiments, the second indication information may further include: an indication of change in CU and/or an identifier of the target CU, or the like.

In some embodiments, the target CU transmits the deciphered or default ciphered second indication information to the IAB child node or the terminal equipment by using a radio resource control (RRC) message.

FIG. 15 is another schematic diagram illustrating an IAB communication method according to an embodiment of this disclosure. As shown in FIG. 15, the target CU transmits a RRC message carrying the second indication information to the handed over or recovered IAB node by using DL RRC MESSAGE TRANSFER, the IAB node transmits the second indication information to the IAB child node or the terminal equipment by using RRC message.

As shown in FIG. 15, the IAB child node or the terminal equipment can obtain the configuration information of the target CU. In addition, the IAB child node or the terminal equipment may also transmit a response message or a completion message to the handed over or recovered IAB node (optional), the IAB node may also transmit information to the target IAB-donor CU by using UL RRC MESSAGE TRANSFER (optional).

How the IAB child node or the terminal equipment correctly obtains the second indication information is described below.

In the process of transmitting the RRC reestablishment request by the IAB child node or the UE, the IAB child node or the UE may configure lower layers to suspend integrity protection and ciphering for SRB1 (NOTE: Ciphering is not applied for the subsequent RRCReestablishment message used to resume the connection. An integrity check is performed by lower layers, but merely upon request from RRC). In the embodiments shown in FIG. 15, since the reestablishment is not initiated by descendant IAB nodes or UE, it need to suspend integrity protection and ciphering for SRB1, that is, no ciphering is performed on the RRC message.

In some embodiments, the IAB child node or the terminal equipment receives a notification message of the IAB node; and the IAB child node or the terminal equipment suspends integrity protection and ciphering for Signaling Radio Bearer (SRB) according to the notification message to obtain the second indication information.

For example, the RLF-recovered or CHO-migrated IAB node notifies the descendant IAB nodes or UE, for example, by transmitting by the signaling of the PHY or MAC or RLC or BAP layer; after the descendant IAB nodes or UE receives the notification, the descendant IAB nodes or UE suspends integrity protection and ciphering for SRB1.

In some embodiments, the IAB child node or the terminal equipment performs deciphering and decoding operations on the radio resource control (RRC) message; and in a case of unsuccessful decoding, no deciphering or default deciphering operation is performed on the radio resource control (RRC) message, and a decoding operation is performed to obtain the second indication information.

For example, when the lower layer (such as the PDCP layer) of the IAB child node or the terminal equipment reports deciphering failure and/or integrity check failure, the RRC layer configures the lower layer (such as PDCP) to not apply deciphering and/or integrity check for SRB1, and then the deciphering and/or integrity check is performed on this PDCP PDU, and if the lower layer deciphering and/or integrity check succeeds, the lower layer transfers the message to the RRC layer.

For another example, the RRC layer of the IAB child node or the terminal equipment configures the lower layer (such as PDCP) to perform integrity protection and ciphering for SRB1, however, if the lower layer deciphering fails and/or the integrity check fails, the lower layer not applies deciphering and/or integrity check, and then performs deciphering and/or integrity check on this PDCP PDU, while if the lower layer deciphering and/or integrity check succeeds, the message is transferred to the RRC layer.

The description is given by taking non-ciphering as an example, however, this disclosure is not limited thereto, for example, default ciphering may also be performed. For example, the ciphered key uses the default key, or the ciphering (or security) algorithm is algorithm 0, or the like.

In some embodiments, the target CU transmits the second indication information to the IAB child node or the terminal equipment by using the configuration information of the source CU via a radio resource control (RRC) message.

For example, the target CU transmits the second indication information using the security algorithms and/or security parameters (such as keys) of the source CU (old CU).

In some embodiments, the target CU transmits the second indication information to the source CU via an Xn interface, and after the source CU processes the second indication information by using the configuration information, the source CU transmits it to the IAB child node or the terminal equipment via the recovered or migrated path.

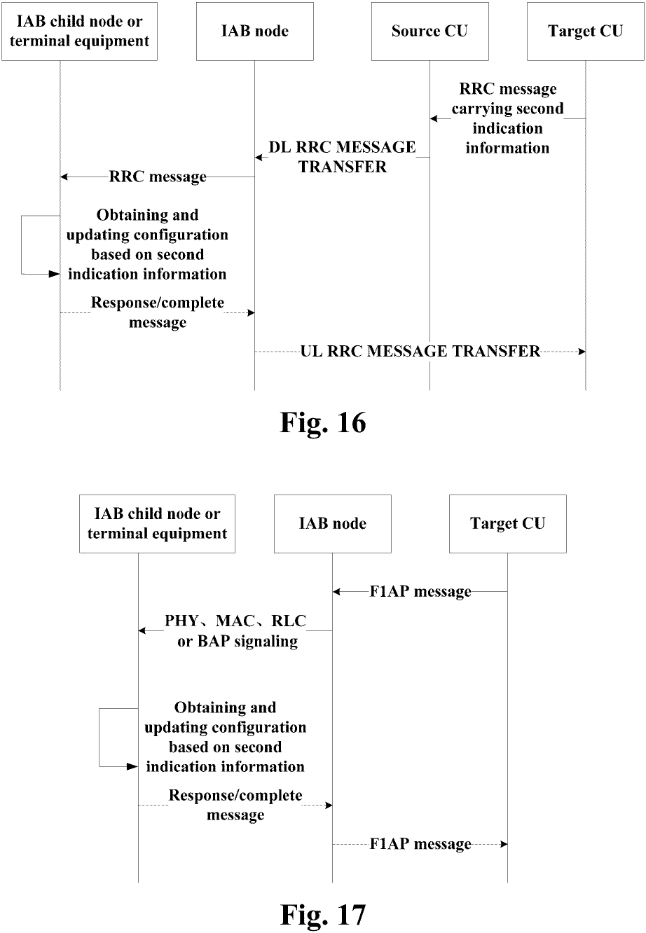

FIG. 16 is another schematic diagram illustrating an IAB communication method according to an embodiment of this disclosure. As shown in FIG. 16, the target CU transmits a RRC message (RRC container included in an XnAP message) carrying the second indication information to the source CU via an Xn interface, after processed by the source CU using security algorithms and/or security parameters (such as keys) (for example, the PDCP layer of the source CU uses the security algorithms and/or security parameters corresponding to the IAB child node or the terminal equipment for ciphering and/or integrity protection), the processed second indication information is transmitted to the IAB node performing the recovery or the CHO by using the FlAP message DL RRC MESSAGE TRANSFER (using a new path), and the IAB node transmits the RRC message containing the processed second indication information to the IAB child node or the terminal equipment.

As shown in FIG. 16, the IAB child node or the terminal equipment can obtain the configuration information of the target CU by using the configuration information of the source CU (such as security algorithms and/or security parameters). In addition, the IAB child node or the terminal equipment can also transmit a response message or a completion message to the handed over or recovered IAB node (optional), such as a RRC reestablishment complete message, or a RRC reconfiguration complete message, or the like. The IAB node can also transmit information to the target IAB-donor CU by using the F1AP message UL RRC MESSAGE TRANSFER (optional).

In some embodiments, the target CU transmits the second indication information to the IAB child node or the terminal equipment by using the FlAP message.

FIG. 17 is another schematic diagram illustrating an IAB communication method according to an embodiment of this disclosure. As shown in FIG. 17, the target CU transmits the F1AP message carrying the second indication information to the recovered or CHOed IAB node, and the IAB node transmits the second indication information to the IAB child node or the terminal equipment by using the PHY, MAC, RLC or BAP signaling.

For example, when the second indication information includes NextHopChainingCount, a 3-bit field may be included in the PHY, MAC, RLC or BAP signaling to indicate the NextHopChainingCount (representing an integer ranging from 0 to 7).

As shown in FIG. 17, the PHY, MAC, RLC or BAP layer of the IAB child node or the terminal equipment may transmit the received second indication information to the RRC layer, and the RRC layer performs an operation of updating the configuration information (for example, updating Keys). In addition, the IAB child node or the terminal equipment can also transmit a response message or a completion message or a HARQ confirmation or a RLC confirmation to recovered or CHOed the IAB node (optional), and the IAB node can also transmit the FlAP message to the target IAB-donor CU (optional).

In some embodiments, the target CU transmits the second indication information to the source CU via an Xn interface, and the source CU transmits the second indication information to a DU of the IAB node by using the F1AP message, and the DU of the IAB node transmits the second indication information to the IAB child node or the terminal equipment.

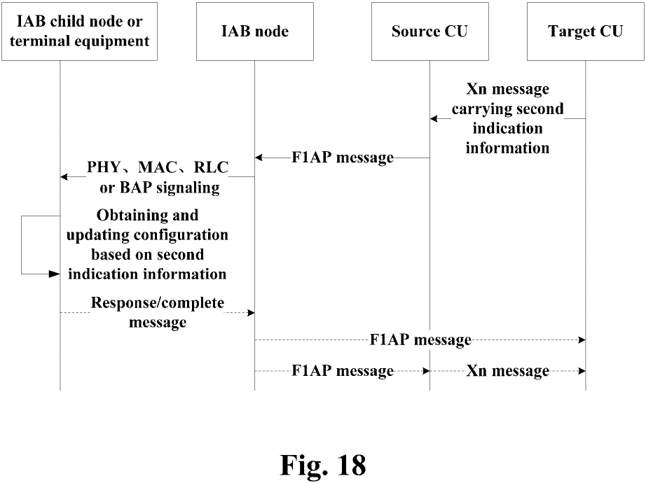

FIG. 18 is another schematic diagram illustrating an IAB communication method according to an embodiment of this disclosure. As shown in FIG. 18, the target CU transmits the second indication information to the source CU via the Xn interface, and the source CU transmits the second indication information to the recovered or CHOed IAB node by using the FlAP message (using a new path), the IAB node transmits the second indication information to the IAB child node or the terminal equipment by using the PHY, MAC, RLC or BAP signaling.

As shown in FIG. 18, the IAB child node or the terminal equipment can transmit the second indication information to the RRC layer, and the RRC layer performs an operation of updating the configuration information (for example, updating Keys). In addition, the IAB child node or the terminal equipment can also transmit a response message or a completion message to the handed over or recovered IAB node (optional), and the IAB node may also transmit the FlAP message to the target IAB-donor CU (optional). Alternatively, the IAB node may also transmit the F1AP message to the source IAB-donor CU (optional), and the source IAB-donor CU may transmit the Xn message to the target IAB-donor CU (optional).

Above description is given by transmitting, by the target CU, the second indication information as an example, and transmitting, by the source CU, fourth indication information is described below.

In some embodiments, the indication information is fourth indication information transmitted by a source CU of an inter-centralized unit (inter-CU) performing a radio link failure (RLF) recovery or a conditional handover (CHO) migration.

In some embodiments, in a process in which the inter-centralized unit (inter-CU) performs the radio link failure (RLF) recovery, in a case where the target CU transmits a radio resource control reestablishment (RRC reestablishment) message or receives a radio resource control reestablishment complete (RRC reestablishment complete) message, or establishes an F1 interface with the IAB node, or transmits BH configuration information, the source CU transmits the fourth indication information to the IAB child node or the terminal equipment.

For example, for an inter-CU RLF recovery scenario, a moment when the fourth indication information is transmitted includes: a moment when the recovered IAB-MT transmits the RRC reestablishment request message, or a moment when the recovered IAB-MT receives the RRC reestablishment message, or a moment when the recovered IAB-MT transmits the RRC reestablishment complete message, or a moment when the MT of the recovered IAB node receives the first RRC reconfiguration message after reestablishing the RRC connection, or a moment when the MT of the recovered IAB node transmits the RRC reconfiguration complete message, or a moment when a DU of the recovered IAB node transmits the FlAP setup request message to the target CU, or a moment when the F1 setup response message is received from the target CU, or a moment when the SCTP connection between the target CU and the recovered IAB node is established, or a moment when the F1-C connection is handed over to use a new TNL address of the recovered IAB node and a new TNL address of the IAB-donor CU,

or a moment when the target CU and the recovered IAB-DU establish or reestablish or update the F1 interface context, such as a moment when the gNB DU configures the update process or the gNB CU configures the update process; or a moment when the target CU and the recovered IAB-DU establish or reestablish or update the FlAP UE context of the child IAB node or the UE of the recovered IAB node; or a moment when the DU of the recovered IAB node receives BH configuration information, where the BH configuration information can include, for example, BH RLC channels and BAP sublayer routing entries on a new path between the target IAB parent node and the target IAB donor DU, or DL mappings of the new path of the recovered IAB node on the target IAB-donor DU; or a moment when F1-U connection (such as GTP tunnel information) is updated, or the like.

In some embodiments, after the inter-centralized unit (inter-CU) performs the radio link failure (RLF) recovery process, the source CU transmits the fourth indication information to the IAB child node or the terminal equipment.

In some embodiments, in a process in which the inter-centralized unit (inter-CU) performs the conditional handover (CHO) migration, in a case where the target CU receives a radio resource control reconfiguration complete message, or establishes an F1 interface with the IAB node, or transmits BH configuration information, the source CU transmits the fourth indication information to the IAB child node or the terminal equipment.

For example, for an inter-CU CHO scenario, a moment when the fourth indication information is transmitted includes: a moment when the IAB node initiates the CHO (for example, detaches from source or starts to apply the stored conditional reconfiguration of a target cell that satisfies conditions or starts to initiate RACH to the target cell), or a moment when the RRC reconfiguration complete message is transmitted, or a moment when a RLC layer confirmation or a HARQ confirmation of the RLC reconfiguration complete message is received, or a moment when a DU of the IAB node transmits the F1AP setup request message to the target CU, or a moment when the F1 setup response message is received from the target CU, or a moment when the SCTP connection between the target CU and the IAB node is established, or a moment when the F1-C connection is handed over to use the new TNL address of the IAB node and the TNL address of the target CU,

or a moment when the target CU and the IAB-DU establish or reestablish or update the F1 interface context, such as a moment when the gNB DU configures the update process or the gNB CU configures the update process; or a moment when the target CU and the DU of the IAB node establish or reestablish or update the F1AP UE context of the child IAB node or the UE of the recovered IAB node; or a moment when the DU of the IAB node receives BH configuration information, where the BH configuration information may include, for example, BH RLC channels and BAP sublayer routing entries on a new path between the target IAB parent node and the target IAB-donor DU, or DL mappings of the new path of the IAB node on the target IAB-donor DU; or a moment when F1-U connection (such as GTP tunnel information) is updated, or the like.

In some embodiments, after the inter-centralized unit (inter-CU) performs the conditional handover (CHO) migration process, the source CU transmits the fourth indication information to the IAB child node or the terminal equipment.

In some embodiments, the fourth indication information indicates configuration information of a radio resource control (RRC) layer and/or a packet data convergence protocol (PDCP) layer in the target CU. For example, the fourth indication information includes at least one or any combination of: a next HopChainingCount, a keySet ChangeIndicator, non-access stratum (NAS) security information (NAS-Container), a ciphering Algorithm, or an integrityProtAlgorithm; however, this disclosure is not limited thereto.

In some embodiments, the fourth indication information may also indicate whether the donor CU of the IAB node has changed, or indicate that the IAB node has performed an intra-CU migration or an inter-CU migration.

In some embodiments, the fourth indication information may further include: an indication of change in CU and/or an identifier of the target CU, or the like.

In some embodiments, the source CU receives the fourth indication information transmitted by the target CU by using a radio resource control (RRC) message, and after the source CU processes the fourth indication information by using the configuration information, the source CU transmits the fourth indication information to a DU of the IAB node via an Xn interface, and the DU of the IAB node transmits it to the IAB child node or the terminal equipment.

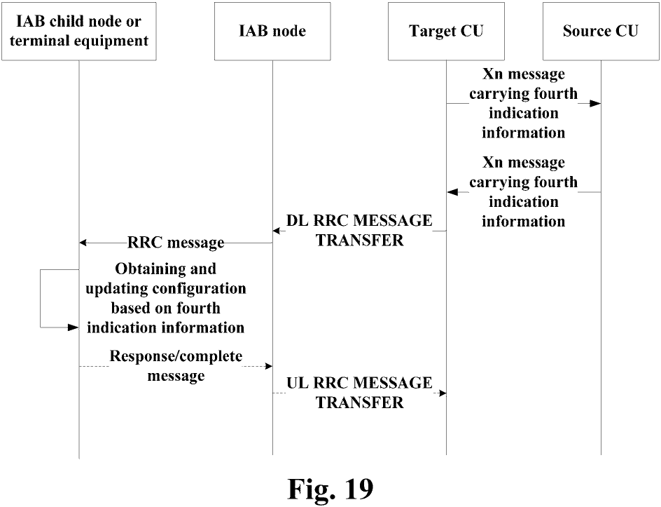

FIG. 19 is another schematic diagram illustrating an IAB communication method according to an embodiment of this disclosure. As shown in FIG. 19, the target CU transmits the RRC message carrying the fourth indication information to the source CU via an Xn interface, and after the source CU processes the RRC message using the configuration information of the source CU (the old security key ciphering and/or integrity protection), the source CU transmits the processed fourth indication information to the target CU via the Xn interface, and the target CU transmits the processed fourth indication information to the recovered or handed over IAB node by using DL RRC MESSAGE TRANSFER (using a new path). The IAB node transmits the processed fourth indication information to the IAB child node or the terminal equipment by using the RRC message.

As shown in FIG. 19, the IAB child node or the terminal equipment may use the configuration information of the source CU (such as security algorithms and/or keys) to obtain the configuration information of the target CU. In addition, the IAB child node or the terminal equipment can also transmit a response message or a complete message to the handed over or recovered IAB node (optional), and the IAB node can also transmit information to the target IAB-donor CU by using UL RRC MESSAGE TRANSFER (optional).

Therefore, by directly transmitting the security-related configuration information, a time delay of cell selection and random access process in the RRC reestablishment process is saved, which is beneficial to reduce the service interruption time of the IAB child node or the terminal equipment due to the IAB node recovery or migration to a new CU.

In the embodiments of this disclosure, the IAB child node or the terminal equipment may indicate its capability to the CU, for example, indicated in the UE capability information or the RRC setup complete message or the RRC resume complete or RRC reestablishment complete message, to indicate whether or not the communication method in the embodiments is supported.

In addition, the RRC message may be, for example, a RRC reestablishment message or a RRC reconfiguration message; the F1AP message may be a UE context setup request or a UE context modification request; the Xn message may be a RRC transfer or a Retrieve UE context response.

It should be noted that FIG. 14 to FIG. 19 can be combined with FIG. 8 or FIG. 9, however, this disclosure is not limited thereto, and can also be combined with other inter-CU recovery or handover process. The embodiments of this disclosure are not limited to the specific steps or order of execution in these processes.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It can be known from the embodiments that the IAB child node or the terminal equipment receives the indication information transmitted by the network device, the indication information indicates the configuration information of the corresponding target CU, and performs communication according to the configuration information of the target CU. Therefore, in a case where the inter-CU recovery or handover is supported, even if the IAB child node or the terminal equipment does not change the serving IAB node, the IAB child node or the terminal equipment may update the configuration information of the CU, so as to correctly communicate with the target CU.

### Embodiments of a Third Aspect

The embodiments of this disclosure provide an IAB communication method described from an IAB node, with contents identical to those in the embodiments of the first and second aspects being not going to be described herein any further. In addition, the embodiments of the third aspect may be implemented in combination with the embodiments of the first and second aspects, or may be implemented independently.

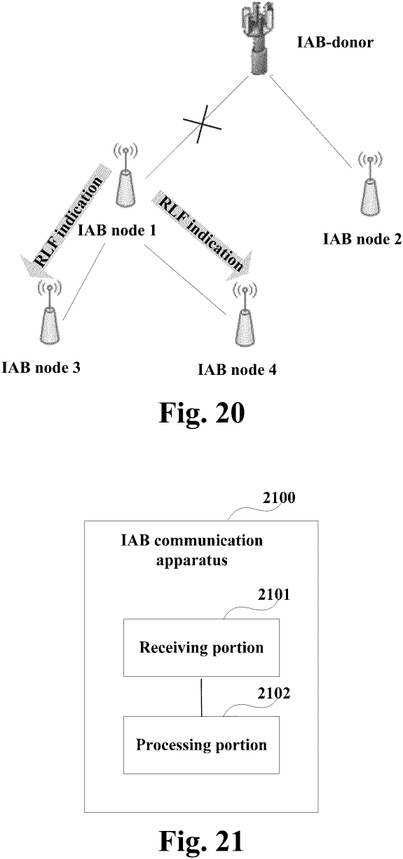

FIG. 20 is a schematic diagram illustrating a scenario of an IAB communication method according to an embodiment of this disclosure. As shown in FIG. 20, in a case of RLF occurs or RLF recovery failure on a backhaul link between an IAB node 1 and its parent node (IAB-donor), the IAB node1 can transmit a RLF indication or a BH RLF indication to a child node of the IAB node 1 (IAB node 3 and IAB node 4) so that the IAB child node can know the case and search for other parent nodes to find a new route to perform communication with the IAB-donor.

In a 3GPP Rel-16 meetings, 4 types of BH RLF indication are discussed. Type 4 is agreed and specified. That is, the type 4 BH RLF indication received by the child node is considered by the child node to detect RLF. In a BAP specification (TS 38.340v16.2.0), a BAP Control PDU format indicated by the BH RLF is shown.

Table 1 shows the the BAP control PDU format indicated by the BH RLF.

TABLE 1

| | | | | |
|---|---|---|---|---|
| D/C | PDU type | R | R | R |

As shown in Table 1, the BAP control PDU includes:

D/C field: 1 bit in length, indicating whether the corresponding BAP PDU is a BAP Data PDU or the BAP Control PDU;

TABLE 2

| Bit | Description |
|---|---|
| 0 | BAP Control PDU |
| 1 | BAP Data PDU |

PDU type: 4 bits in length, indicating a type of control information included in the corresponding BAP Control PDU.

TABLE 3

| Bit | Description |
|---|---|
| 0000 | Flow control feedback per BH RLC channel |
| 0001 | Flow control feedback per BAP routing ID |
| 0010 | Flow control feedback polling |
| 0011 | BH RLF indication |
| 0100-1111 | Reserved |

As shown in Table 1, the BAP control PDU further includes R bits, which are 1 bit respectively; 3 R bits, which are 3 bits in total.

In Rel-17, in order to provide some information to the child node earlier, speed up the recovery process of the child node, and reduce the service interruption of the child node, 3GPP is discussing whether type 1 to type 3 of RLF indications are required, and behaviors of the child node receives these types of RLF indications. However, the current RLF indication of the BAP layer is only for type 4, while the type 1 to type 3 of RLF indications cannot be implemented.

In some embodiments, the IAB node detects that in the backhaul link between the IAB node and the parent node, the radio link failure (RLF) occurs or the RLF recovery is being attempted or the RLF recovery successes or the RLF recovery fails; and the IAB node transmits the RLF indication information to the serving IAB child node or terminal equipment; the RLF indication information indicates one of at least two types of backhaul link radio link failure (BH RLF).

For example, the type of the backhaul link radio link failure includes at least one of:
type 1 backhaul link radio link failure, which indicates that the IAB node detects that the radio link failure (RLF) occurs in the backhaul link between the IAB node and the parent node;
type 2 backhaul link radio link failure, which indicates that the IAB node detects that the radio link failure (RLF) occurs in the backhaul link between the IAB node and the parent node and the IAB node is attempting the RLF recovery;
type 3 backhaul link radio link failure, which indicates that the IAB node detects that the radio link failure (RLF) occurs in the backhaul link between the IAB node and the parent node and the RLF recovery of the IAB node succeeds; or
type 4 backhaul link radio link failure, which indicates that the IAB node detects that the radio link failure (RLF) occurs in the backhaul link between the IAB node and the parent node and the RLF recovery of the IAB node fails.

In some embodiments, the RLF indication information is transmitted to the IAB child node or the terminal equipment by using the BAP control PDU; a PDU type field in the BAP control PDU indicates a type of the backhaul link radio link failure.

In some embodiments, one value of more than one bit in the PDU type field in the BAP control PDU indicates the type 4 backhaul link radio link failure; and the other value indicates the type 2 backhaul link radio link failure or the type 3 backhaul link radio link failure. For example, as shown in Table 4:

TABLE 4

| Bit | Description |
|---|---|
| 0000 | Flow control feedback per BH RLC channel |
| 0001 | Flow control feedback per BAP routing ID |
| 0010 | Flow control feedback polling |
| 0011 | BH RLF indication type 4 |
| 0100 | BH RLF indication type 2 or 3 |
| 0101-1111 | Reserved |

In some embodiments, one value of the plurality of bits in the PDU type field in the BAP control PDU indicates the type 4 backhaul link radio link failure; other value indicates the type 1 backhaul link radio link failure or type 2 backhaul link radio link failure or one of type 1 backhaul link radio link failure and type 2 backhaul link radio link failure; and another value indicates the type 3 backhaul link radio link failure. For example, as shown in Table 5 (where a value 0100 of PDU type indicates BH RLF indication type 2):

TABLE 5

| Bit | Description |
|---|---|
| 0000 | Flow control feedback per BH RLC channel |
| 0001 | Flow control feedback per BAP routing ID |
| 0010 | Flow control feedback polling |
| 0011 | BH RLF indication type 4 |
| 0100 | BH RLF indication type 2 |
| 0101 | BH RLF indication type 3 |
| 0110-1111 | Reserved |

In some embodiments, the R field of the BAP control PDU using the RLF indication information indicates the at least two types of backhaul link radio link failure.

For example, one value of 1 bit in the R field of the BAP control PDU indicates the type 4 backhaul link radio link failure; the other value indicates the type 2 backhaul link radio link failure or type 3 backhaul link radio link failure. For example, 0 means the type 4 and 1 means the type 2.

TABLE 6

| | | | | |
|---|---|---|---|---|
| D/C | PDU type | RLF type | R | R |

For another example, one value of the plurality of bits in the R field of the BAP control PDU indicates the type 4 backhaul link radio link failure; other value indicates the type 2 backhaul link radio link failure; and another value indicates the type 3 backhaul link radio link failure.

TABLE 7

| | | | |
|---|---|---|---|
| D/C | PDU type | RLF type | R |

In some embodiments, the type 3 RLF indication may indicate whether the IAB node is recovered to another IAB-donor CU, that is, whether the radio link failure recovered IAB-donor CU is the same as the source IAB-donor CU of the IAB node or whether the IAB-donor CU is changed, for example, a field with a length of 1 bit is used.

In some embodiments, in a case where the IAB node is successfully recovered to another IAB-donor CU, the type 3 RLF indication may indicate an identifier or index of the recovered CU, or the like.

In some embodiments, when the IAB child node or the terminal equipment receives the type 2 RLF indication or type 3 RLF indication or type 4 RLF indication, if the IAB child node or the terminal equipment is configured with a CHO, a CHO process may be initiated, otherwise, a radio link failure recovery process may be initiated.

In some embodiments, the IAB child node may generate a RLF indication when receiving the RLF indication, and the IAB child node transmits the generated RLF indication to the child node or the terminal equipment of the IAB child node.

For example, when the IAB child node receives the type 1 or type 2 RLF indication, one of the type 1 and type 2 RLF indications may be generated, or when the IAB child node receives the type 3 RLF indication, the IAB child node may generate the type 3 RLF indication, or when the IAB child node receives the type 4 RLF indication, the IAB child node may generate the type 4 RLF indication.

In some embodiments, when the IAB child node receives the type 1 or type 2 or type 3 or type 4 of RLF indication, the IAB child node may forward the RLF indication to the child node or the terminal equipment of the IAB child node.

In some embodiments, when he IAB child node receives the type 1 or type 2 or type 3 or type 4 of RLF indication, the IAB child node may stop transmitting a scheduling request (SR) and/or a buffer status report (BSR) to the IAB node.

In some embodiments, when the IAB child node receives the type 1 or type 2 or type 3 or type 4 of RLF indication, the IAB-support field in the system information block type 1 (SIB1) of a cell under the IAB child node does not appear.

In some embodiments, behaviors of the IAB child node when receiving the RLF indication are configurable, for example, the IAB-donor CU may configure the IAB child node to adopt the behaviors in the above embodiments.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It can be seen from the embodiments that the RLF indication information indicates one of at least two types of backhaul link radio link failure (BH link RLF), which can provide some information to the child node earlier, speed up the recovery process of the child node, and reduce the service interruption of the child node.

### Embodiments of a Fourth Aspect

The embodiments of this disclosure provide an IAB communication method described from an IAB node, with the contents identical to those in the embodiments of the first to third aspects being not going to be described herein any further. In addition, the embodiments of the fourth aspect may be implemented in combination with the embodiments of the first to third aspects, or may be implemented independently.

As mentioned above, the RLF indication is indicated by the BAP control PDU. Since the IAB child node has the BAP layer, but the terminal equipment does not have the BAP layer, the current RLF indication is not suitable for notifying the terminal equipment to perform related operations.

In some embodiments, the IAB node detects that in the backhaul link between the IAB node and the parent node, the radio link failure (RLF) occurs or the RLF recovery is being attempted or the RLF recovery successes or the RLF recovery fails; and the IAB node transmits the RLF indication information to the served terminal equipment by using physical layer signaling, MAC layer signaling, RLC layer signaling or system information.

In some embodiments, the IAB node transmits the RLF indication information to the serving IAB child node by using the BAP control PDU, or the IAB node uses the physical layer signaling, the MAC layer signaling, the RLC layer signaling, or the system information to transmit the RLF indication information to the serving IAB child node.

In some embodiments, the physical layer signaling includes: a downlink control information (DCI) format, the downlink control information (DCI) indicating a type of backhaul link radio link failure. For example, a new DCI format may be designed for the PHY, or the BH RLF indication and/or the BH RLF indication type may be explicitly indicated in the DCI.

In some embodiments, the MAC layer signaling includes a MAC CE; one or more bits or one field in the MAC CE indicate the type of backhaul link radio link failure. For example, a new MAC CE may be used with a new LCID.

For example, the MAC CE is identified by a corresponding MAC sub-header, and the MAC sub-header includes a LCID corresponding to the MAC CE. For another example, the MAC CE may include a bitmap, wherein each bit represents a type. For 1 bit, for example, 1 indicates that it is this type of BH RLF indication, and 0 indicates that it is not this type of BH RLF indication. For another example, there may be a field in the MAC CE that explicitly indicates which type it is.

In some embodiments, the RLC layer signaling includes RLC control PDUs.

In some embodiments, the system information includes a main information block (MIB) and/or a system information block (SIB); a field in the MIB and/or SIB indicates a type of backhaul link radio link failure.

For example, the IAB-DU transmits the MIB and/or SIB1 autonomously. For example, the cellBarred field in the MIB is set to be barred or the IAB-support field in the SIB1 does not appear, or the MIB and/or SIB1 indicates the BH RLF indication and/or BH RLF indication type using a new field.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It can be known from the embodiments that the IAB node transmits the RLF indication information to the terminal equipment by using the physical layer signaling, the MAC layer signaling, the RLC layer signaling or the system information. The IAB node may indicate to the terminal equipment that BH RLF occurs in its serving IAB node, which helps to reduce the service interruption delay caused by the RLF recovery.

### Embodiments of a Fifth Aspect

The embodiments of this disclosure provide an IAB communication apparatus. The device may be, for example, an IAB child node or terminal equipment, or one or some components or assemblies configured in the IAB child node or the terminal equipment, and contents identical to those in the embodiments of the first and second aspects shall not be described herein any further.

FIG. 21 is a schematic diagram illustrating an IAB communication apparatus according to an embodiment of this disclosure. As shown in FIG. 21, the IAB communication apparatus 2100 includes: a receiving portion 2101 and a processing portion 2102.

In some embodiments, the receiving portion 2101 receives indication information transmitted by a network device, the indication information being used to indicate that an IAB child node or terminal equipment deems that a radio link failure (RLF) is detected or indicate that the IAB child node or the terminal equipment initiates a connection reestablishment in a case where an IAB node where the IAB child node or the terminal equipment is present performs an inter-centralized unit (inter-CU) recovery or migration; and the processing portion 2102 initiates a radio link failure recovery process or a connection reestablishment process.

In some embodiments, the indication information is first indication information transmitted by an IAB node of an inter-centralized unit (inter-CU) in performing a radio link failure (RLF) recovery or a conditional handover (CHO) migration.

In some embodiments, in a process in which the inter-centralized unit (inter-CU) performs a radio link failure (RLF) recovery, in a case where the IAB node receives a radio resource control reestablishment (RRC reestablishment) message transmitted by a target centralized unit (target CU), or establishes an F1 interface with the target CU, or receives backhaul (BH) configuration information, the IAB node transmits the first indication information to the IAB child node or the terminal equipment.

In some embodiments, after the inter-centralized unit (inter-CU) performs the radio link failure (RLF) recovery process, the IAB node transmits the first indication information to the IAB child node or the terminal equipment.

In some embodiments, the processing portion 2102 is further configured to: in a case where the IAB child node or the terminal equipment is configured with single-connectivity, or in a case where the IAB child node or the terminal equipment is configured with dual-connectivity and the IAB node is a master cell group (MCG) of the IAB child node or the terminal equipment, determine that a radio link failure (RLF) is detected for the MCG.

In some embodiments, the processing portion 2102 is configured to: in a case where a timer (T316) is configured, and a SCG transmission is not suspended and a PSCell change is not in progress, initiate a MCG failure information process to report a MCG radio link failure, otherwise initiate the connection reestablishment process.

In some embodiments, the processing portion 2102 is further configured to: in a case where the IAB child node or the terminal equipment is configured with dual connectivity and the IAB node is a secondary cell group (SCG) of the IAB child node or the terminal equipment, determine that the radio link failure (RLF) is detected for the SCG.

In some embodiments, the processing portion 2102 is configured to: in a case where the MCG transmission is not suspended, initiate a SCG failure information process to report a SCG radio link failure, otherwise initiate the connection reestablishment process.

In some embodiments, in a process in which the inter-centralized unit (inter-CU) performs the conditional handover (CHO) migration, in a case where the IAB node initiates a conditional handover (CHO), or transmits a radio resource control reconfiguration complete (RRC reconfiguration complete) message, or establishes an F1 interface with the target CU, or receives BH configuration information, the IAB node transmits the first indication information to the IAB child node or the terminal equipment.

In some embodiments, after the inter-centralized unit (inter-CU) performs the conditional handover (CHO) migration process, the IAB node transmits the first indication information to the IAB child node or the terminal equipment.

In some embodiments, the first indication information includes at least one or any combination of: a backhaul adaptation protocol (BAP) protocol data unit (PDU), a radio link control (RLC) PDU, a medium access control (MAC) control element (CE), a medium access control (MAC) subheader, or physical layer signaling.

In some embodiments, the indication information is third indication information transmitted via a recovered or migrated path by a source centralized unit (source CU) of the inter-centralized unit (inter-CU) performing the radio link failure (RLF) recovery or the conditional handover (CHO) migration.

In some embodiments, the source centralized unit (CU) transmits the third indication information to the target CU or a distributed unit (DU) of the IAB node via an Xn interface, and the target CU or the DU transmits the third indication information to the IAB child node or the terminal equipment.

In some embodiments, in a process in which the inter-centralized unit (inter-CU) performs the radio link failure (RLF) recovery process, in a case where the source CU receives a retrieval context request message transmitted by the target CU, or in a case where a retrieval context response message is transmitted to the target CU, or in a case where a context release message transmitted by the target CU is received, the source CU transmits the third indication information.

In some embodiments, after the inter-centralized unit (inter-CU) performs the radio link failure (RLF) recovery process, the source CU transmits the third indication information.

In some embodiments, in a process in which the inter-centralized unit (inter-CU) performs the conditional handover (CHO) migration, the source CU transmits the third indication information in a case of receiving the context release message transmitted by the target CU.

In some embodiments, after the inter-centralized unit (inter-CU) performs the conditional handover (CHO) migration process, the source CU transmits the third indication information.

In some embodiments, the third indication information includes at least one or any combination of: a packet data convergence protocol (PDCP) protocol data unit (PDU), a radio resource control (RRC) message, or an F1AP message.

In some embodiments, the receiving portion 2101 receives indication information transmitted by a network device, the indication information being used to indicate configuration information of a target centralized unit (CU) to which an IAB child node or terminal equipment corresponds in a case where an IAB node where the IAB child node or the terminal equipment is present performs an inter-centralized unit (inter-CU) recovery or migration; and the processing portion 2102 performs communication according to the configuration information of the target CU.

In some embodiments, the indication information is second indication information transmitted by the target CU of the inter-centralized unit (inter-CU) performing the radio link failure (RLF) recovery or the conditional handover (CHO) migration.

In some embodiments, in a process in which the inter-centralized unit (inter-CU) performs the radio link failure (RLF) recovery, in a case where the target CU transmits a radio resource control reestablishment (RRC reestablishment) message, or receives a radio resource control reestablishment complete (RRC reestablishment complete) message, or establishes an F1 interface with the IAB node, or transmits backhaul (BH) configuration information, the target CU transmits the second indication information to the IAB child node or the terminal equipment.

In some embodiments, after the inter-centralized unit (inter-CU) performs the radio link failure (RLF) recovery process, the target CU transmits the second indication information to the IAB child node or the terminal equipment.

In some embodiments, in a process in which the inter-centralized unit (inter-CU) performs the conditional handover (CHO) migration, in a case where the target CU receives a radio resource control reconfiguration complete message, or establishes an F1 interface with the IAB node, or transmits backhaul (BH) configuration information, the target CU transmits the second indication information to the IAB child node or the terminal equipment.

In some embodiments, after the inter-centralized unit (inter-CU) performs the conditional handover (CHO) migration process, the target CU transmits the second indication information to the IAB child node or the terminal equipment.

In some embodiments, the second indication information indicates configuration information of a radio resource control (RRC) layer and/or a packet data convergence protocol (PDCP) layer in the target CU;

In some embodiments, the second indication information includes at least one or any combination of: a nextHopChainingCount, a keySetChangeIndicator, non-access stratum (NAS) security information (NAS-Container), a ciphering Algorithm, or an integrityProtAlgorithm.

In some embodiments, the target CU transmits the second indication information that is deciphered or default ciphered to the IAB child node or the terminal equipment by using a radio resource control (RRC) message.

In some embodiments, the processing portion 2102 is further configured to: receive a notification message of the IAB node; and suspend integrity protection and ciphering operations for a signaling radio bearer (SRB) according to the notification message to obtain the second indication information.

In some embodiments, the processing portion 2102 is further configured to: perform deciphering and decoding operations for the radio resource control (RRC) message; and in a case of failing to successfully decode the radio resource control (RRC) message, deciphering or default deciphering operation is not performed for the radio resource control (RRC) message, and a decoding operation is performed to obtain the second indication information.

In some embodiments, the target CU transmits the second indication information to the IAB child node or the terminal equipment by using the configuration information of the source CU via a radio resource control (RRC) message.

In some embodiments, the target CU transmits the second indication information to the source CU via an Xn interface, and after the source CU processes the second indication information by using the configuration information, the source CU transmits it to the IAB child node or the terminal equipment via the recovered or migrated path.

In some embodiments, the target CU transmits the second indication information to the IAB child node or the terminal equipment by using an F1AP message.

In some embodiments, the target CU transmits the second indication information to the source CU via the Xn interface, and the source CU transmits the second indication information to a DU of the IAB node by using the F1AP message, and the DU of the IAB node transmits it to the IAB child node or the terminal equipment.

In some embodiments, the indication information is fourth indication information transmitted by the source CU of the inter-centralized unit (inter-CU) performing the radio link failure (RLF) recovery or the conditional handover (CHO) migration.

In some embodiments, in a process in which the inter-centralized unit (inter-CU) performs the radio link failure (RLF) recovery, in a case where the target CU transmits a radio resource control reestablishment (RRC reestablishment) message, or receives a radio resource control reestablishment complete (RRC reestablishment complete) message, or establishes an F1 interface with the IAB node, or transmits BH configuration information, the source CU transmits the fourth indication information to the IAB child node or the terminal equipment.

In some embodiments, after the inter-centralized unit (inter-CU) performs the radio link failure (RLF) recovery process, the source CU transmits the fourth indication information to the IAB child node or the terminal equipment.

In some embodiments, in a process in which the inter-centralized unit (inter-CU) performs the conditional handover (CHO) migration, in a case where the target CU receives a radio resource control reconfiguration complete message, or establishes an F1 interface with the IAB node, or transmits BH configuration information, the source CU transmits the fourth indication information to the IAB child node or the terminal equipment.

In some embodiments, after the inter-centralized unit (inter-CU) performs the conditional handover (CHO) migration process, the source CU transmits the fourth indication information to the IAB child node or the terminal equipment.

In some embodiments, the fourth indication information indicates configuration information of a radio resource control (RRC) layer and/or a packet data convergence protocol (PDCP) layer in the target CU.

In some embodiments, the fourth indication information includes at least one or any combination of: a nextHopChainingCount, a keySet ChangeIndicator, non-access stratum (NAS) security information (NAS-Container), a ciphering Algorithm, or an integrityProtAlgorithm.

In some embodiments, the source CU receives the fourth indication information transmitted by the target CU by using a radio resource control (RRC) message, and after the source CU processes the fourth indication information by using the configuration information, the source CU transmits it to the DU of the IAB node via the Xn interface, and the DU of the IAB node transmits it to the IAB child node or the terminal equipment.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above, however, this disclosure is not limited thereto. The IAB communication apparatus 2100 may further include other components or modules, and reference may be made to related techniques for particulars of these components or modules.

Furthermore, for the sake of simplicity, connection relationships between the components or modules or signal profiles thereof are only illustrated in FIG. 21. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

It can be known from the embodiments that the IAB child node or the terminal equipment receives the indication information transmitted by the network device, and initiates the radio link failure recovery process or the connection reestablishment process according to the indication information; or the IAB child node or the terminal equipment receives the indication information transmitted by the network device, the indication information indicates the configuration information of the corresponding target CU, and perform communication according to the configuration information of the target CU. Therefore, in a case where the inter-CU recovery or handover is supported, even if the IAB child node or the terminal equipment does not change the serving IAB node, the IAB child node or the terminal equipment may update the configuration information of the CU, so as to correctly communicate with the target CU.

### Embodiments of a Sixth Aspect

The embodiments of this disclosure provide an IAB communication apparatus. The device may be, for example, an IAB node, or may be one or more components or assemblies configured in the IAB node. The IAB communication apparatus in the embodiments of the sixth aspect corresponds to the IAB communication apparatus in the embodiments of the fifth aspect, and contents identical to those in the embodiments of the first and second aspects shall not be described herein any further.

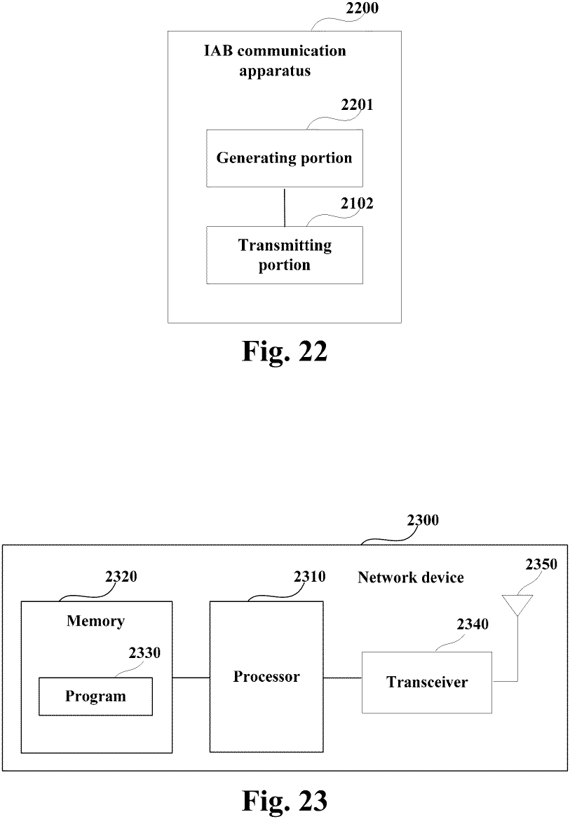

FIG. 22 is a schematic diagram illustrating an IAB communication apparatus according to an embodiment of this disclosure. As shown in FIG. 22, an IAB communication apparatus 2200 includes: a generating portion 2201 and a transmitting portion 2202.

In some embodiments, the generating portion 2201 generates indication information; the indication information is used to indicate that an IAB child node or terminal equipment deems that a radio link failure (RLF) is detected or indicate that the IAB child node or the terminal equipment initiates a connection reestablishment in a case where an IAB node where the IAB child node or the terminal equipment is present performs an inter-centralized unit (inter-CU) recovery or migration; and the transmitting portion 2202 transmits the indication information to the IAB child node or the terminal equipment.

In some embodiments, the IAB communication apparatus 2200 is an IAB node of an inter-centralized unit (inter-CU) performing a radio link failure (RLF) recovery or a conditional handover (CHO) migration. The indication information is first indication information transmitted by the IAB node of the inter-centralized unit (inter-CU) performing the radio link failure (RLF) recovery or the conditional handover (CHO) migration.

In some embodiments, in a process in which the inter-centralized unit (inter-CU) performs the radio link failure (RLF) recovery, in a case where the IAB node receives a radio resource control (RRC) reestablishment message transmitted by a target centralized unit (target CU), or establishes an F1 interface with the target CU, or receives backhaul (BH) configuration information, the IAB node transmits the first indication information to the IAB child node or the terminal equipment.

In some embodiments, after the inter-centralized unit (inter-CU) performs the radio link failure (RLF) recovery process, the IAB node transmits the first indication information to the IAB child node or the terminal equipment.

In some embodiments, in a process in which the inter-centralized unit (inter-CU) performs the conditional handover (CHO) migration, in a case where the IAB node initiates a conditional handover (CHO), or transmits a radio resource control reconfiguration complete (RRC reconfiguration complete) message, or establishes an F1 interface with the target CU, or receives BH configuration information, the IAB node transmits the first indication information to the IAB child node or the terminal equipment.

In some embodiments, after the inter-centralized unit (inter-CU) performs the conditional handover (CHO) migration process, the IAB node transmits the first indication information to the IAB child node or the terminal equipment.

In some embodiments, the first indication information includes at least one or any combination of: a backhaul adaptation protocol (BAP) protocol data unit (PDU), a radio link control (RLC) PDU, a medium access control (MAC) control element (CE), a medium access control (MAC) subheader, or physical layer signaling.

In some embodiments, the IAB communication apparatus 2200 is a source CU of an inter-centralized unit (inter-CU) performing a radio link failure (RLF) recovery or a conditional handover (CHO) migration. The indication information is third indication information transmitted by the source centralized unit (source CU) of the inter-centralized unit (inter-CU) performing the radio link failure (RLF) recovery or the conditional handover (CHO) migration via the recovered or migrated path.

In some embodiments, the source centralized unit (CU) transmits the third indication information to the target CU or a distributed unit (DU) of the IAB node via an Xn interface, and the target CU or the DU transmits the third indication information to the IAB child node or the terminal equipment.

In some embodiments, in a process in which the inter-centralized unit (inter-CU) performs the radio link failure (RLF) recovery, in a case where the source CU receives a retrieval context request message transmitted by the target CU, or in a case where a retrieval context response message is transmitted to the target CU, or in a case where a context release message transmitted by the target CU is received, the source CU transmits the third indication information.

In some embodiments, after the inter-centralized unit (inter-CU) performs the radio link failure (RLF) recovery process, the source CU transmits the third indication information.

In some embodiments, in a process in which the inter-centralized unit (inter-CU) performs the conditional handover (CHO) migration, the source CU transmits the third indication information in a case of receiving the context release message transmitted by the target CU.

In some embodiments, after the inter-centralized unit (inter-CU) performs the conditional handover (CHO) migration process, the source CU transmits the third indication information.

In some embodiments, the third indication information includes at least one or any combination of: a packet data convergence protocol (PDCP) protocol data unit (PDU), a radio resource control (RRC) message, or an F1AP message.

In some embodiments, the generating portion 2201 generates indication information; the indication information is used to indicate that the configuration information of the target CU corresponding to the IAB child node or the terminal equipment in a case where an IAB node where the IAB child node or the terminal equipment is present performs an inter-centralized unit (inter-CU) recovery or migration; and the transmitting portion 2202 transmits the configuration information of the target CU to the IAB child node or the terminal equipment.

In some embodiments, the IAB communication apparatus 2200 is a target CU of the inter-centralized unit (inter-CU) performing the radio link failure (RLF) recovery or the conditional handover (CHO) migration. The indication information is second indication information transmitted by the target CU of the inter-centralized unit (inter-CU) performing the radio link failure (RLF) recovery or the conditional handover (CHO) migration.

In some embodiments, in a process in which the inter-centralized unit (inter-CU) performs the radio link failure (RLF) recovery, in a case where the target CU transmits a radio resource control reestablishment (RRC reestablishment) message, or receives a radio resource control reestablishment complete (RRC reestablishment complete) message, or establishes an F1 interface with the IAB node, or transmits BH configuration information, the target CU transmits the second indication information to the IAB child node or the terminal equipment.

In some embodiments, after the inter-centralized unit (inter-CU) performs the radio link failure (RLF) recovery process, the target CU transmits the second indication information to the IAB child node or the terminal equipment.

In some embodiments, in a process in which the inter-centralized unit (inter-CU) performs the conditional handover (CHO) migration, in a case where the target CU receives a radio resource control reconfiguration complete message, or establishes an F1 interface with the IAB node, or transmits BH configuration information, the target CU transmits the second indication information to the IAB child node or the terminal equipment.

In some embodiments, after the inter-centralized unit (inter-CU) performs the conditional handover (CHO) migration process, the target CU transmits the second indication information to the IAB child node or the terminal equipment.

In some embodiments, the second indication information indicates configuration information of a radio resource control (RRC) layer and/or a packet data convergence protocol (PDCP) layer in the target CU. For example, the second indication information includes at least one or any combination of: a nextHopChainingCount, a keySetChangeIndicator, non-access stratum (NAS) security information (NAS-Container), a ciphering Algorithm, or an integrityProtAlgorithm.

In some embodiments, the target CU transmits the second indication information that is deciphered or default ciphered to the IAB child node or the terminal equipment by using a radio resource control (RRC) message.

In some embodiments, the target CU transmits the second indication information to the IAB child node or the terminal equipment by using the configuration information of the source CU via the radio resource control (RRC) message.

In some embodiments, the target CU transmits the second indication information to the source CU via an Xn interface, and after the source CU processes the second indication information by using the configuration information, the source CU transmits it to the IAB child node or the terminal equipment via the recovered or migrated path.

In some embodiments, the target CU transmits the second indication information to the IAB child node or the terminal equipment by using an F1AP message.

In some embodiments, the target CU transmits the second indication information to the source CU via the Xn interface, and the source CU transmits the second indication information to a DU of the IAB node by using the F1AP message, and the DU of the IAB node transmits the second indication information to the IAB child node or the terminal equipment.

In some embodiments, the IAB communication apparatus 2200 is the source CU of the inter-centralized unit (inter-CU) performing the radio link failure (RLF) recovery or the conditional handover (CHO) migration. The indication information is fourth indication information transmitted by the source CU of the inter-centralized unit (inter-CU) performing the radio link failure (RLF) recovery or the conditional handover (CHO) migration.

In some embodiments, in a process in which the inter-centralized unit (inter-CU) performs the radio link failure (RLF) recovery, in a case where the target CU transmits a radio resource control reestablishment (RRC reestablishment) message, or receives a radio resource control reestablishment complete (RRC reestablishment complete) message, or establishes an F1 interface with the IAB node, or transmits BH configuration information, the source CU transmits the fourth indication information to the IAB child node or the terminal equipment.

In some embodiments, after the inter-centralized unit (inter-CU) performs the radio link failure (RLF) recovery process, the source CU transmits the fourth indication information to the IAB child node or the terminal equipment.

In some embodiments, in a process in which the inter-centralized unit (inter-CU) performs the conditional handover (CHO) migration, in a case where the target CU receives a radio resource control reconfiguration complete message, or establishes an F1 interface with the IAB node, or transmits BH configuration information, the source CU transmits the fourth indication information to the IAB child node or the terminal equipment.

In some embodiments, the source after the inter-centralized unit (inter-CU) performs the conditional handover (CHO) migration process, CU transmits the fourth indication information to the IAB child node or the terminal equipment.

In some embodiments, the fourth indication information indicates configuration information of a radio resource control (RRC) layer and/or a packet data convergence protocol (PDCP) layer in the target CU. For example, the fourth indication information includes at least one or any combination of: a nextHopChainingCount, a keySet ChangeIndicator, non-access stratum (NAS) security information (NAS-Container), a ciphering Algorithm, or an integrityProtAlgorithm.

In some embodiments, the source CU receives the fourth indication information transmitted by the target CU by using a radio resource control (RRC) message, after the source CU processs the fourth indication information by using the configuration information, the source CU transmits it to a DU of the IAB node via an Xn interface, and the DU of the IAB node transmits it to the IAB child node or the terminal equipment.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above, however, this disclosure is not limited thereto. The IAB communication apparatus 2200 may further include other components or modules, and reference may be made to related techniques for particulars of these components or modules.

Furthermore, for the sake of simplicity, connection relationships between the components or modules or signal profiles thereof are only illustrated in FIG. 22. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

It can be known from the embodiments that the IAB node transmits the indication information to the IAB child node or the terminal equipment, and the IAB child node or the terminal equipment initiates the radio link failure recovery process or the connection reestablishment process according to the indication information, or performs communication according to the configuration information of the target CU. Therefore, in a case where the inter-CU recovery or handover is supported, even if the IAB child node or the terminal equipment does not change the serving IAB node, the IAB child node or the terminal equipment may update the configuration information of the CU, so as to correctly communicate with the target CU.

### Embodiments of a Seventh Aspect

The embodiments of this disclosure further provide a communication system. Reference may be made to FIG. 1, with contents identical to those in the embodiments of the first to the sixth aspects being not going to be described herein any further.

In some embodiments, the communication system may include: the IAB communication apparatus 2100 according to the embodiment of the fifth aspect and the IAB communication apparatus 2200 according to the embodiment of the sixth aspect, which perform the IAB communication method in the embodiments of the first and second aspects.

In some embodiments, the communication system may include: an IAB node, which implements the IAB communication method in the embodiments of the third and fourth aspects.

An embodiment of this disclosure also provides a network device, which may be, for example, a base station or an IAB node, however, this disclosure is not limited thereto, and may also be other network device.

FIG. 23 is a schematic diagram illustrating a network device according to an embodiment of this disclosure. As shown in FIG. 23, a network device 2300 may include: a processor 2310 (such as, a central processing unit (CPU)) and a memory 2320 coupled to the processor 2310. The memory 2320 can store a variety of data. In addition, a program 2330 for information processing is also stored, and the program 2330 is executed under the control of the processor 2310.

For example, the processor 2310 may be configured to execute a program in order to implement the IAB communication method in the embodiments of the first aspect. For example, the processor 2310 may be configured to: generate indication information, the indication information being used to indicate that an IAB child node or terminal equipment deems that a radio link failure (RLF) is detected or indicate that the IAB child node or the terminal equipment initiates a connection reestablishment in a case where an IAB node where the IAB child node or the terminal equipment is present performs an inter-centralized unit (inter-CU) recovery or migration; and transmit the indication information to the IAB child node or the terminal equipment.

For example, the processor 2310 may be configured to execute a program in order to implement the IAB communication method in the embodiments of the second aspect. For example, the processor 2310 may be configured to: generate indication information, the indication information being used to indicate configuration information of a target-centralized unit (target CU) to which an IAB child node or terminal equipment corresponds in a case where an IAB node where the IAB child node or the terminal equipment is present performs an inter-centralized unit (inter-CU) recovery or migration; and transmit configuration information of the target CU to the IAB child node or the terminal equipment.

For example, the processor 2310 may be configured to execute a program in order to implement the IAB communication method in the embodiments of the third aspect. For example, the processor 2310 may be configured to: detect that in the backhaul link between the IAB node and the parent node, a radio link failure (RLF) occurs or a RLF recovery is being attempted or the RLF recovery successes or the RLF recovery fails; and transmit RLF indication information to the affiliated IAB child node or terminal equipment. The RLF indication information indicates one of at least two types of backhaul link radio link failure (BH link RLF).

For another example, the processor 2310 may be configured to execute a program in order to implement the IAB communication method in the embodiments of the fourth aspect. For example, the processor 2310 may be configured to: detect that in the backhaul link between the IAB node and the parent node, the radio link failure (RLF) occurs or the RLF recovery is being attempted or the RLF recovery successes or RLF recovery fails; use BAP control PDU to transmit RLF indication information to the affiliated IAB child node; and use physical layer signaling, MAC layer signaling, RLC layer signaling or system information to transmit the RLF indication information to the affiliated terminal equipment.

In addition, as shown in FIG. 23, the network device 2300 may further include: a transceiver 2340, an antenna 2350, or the like, wherein functions of the above components are similar to those in the relevant art, which shall not be described herein any further. It should be noted that the network device 2300 does not necessarily include all the parts shown in FIG. 23. Furthermore, the network device 2300 may also include parts not shown in FIG. 23, and the related art may be referred to.

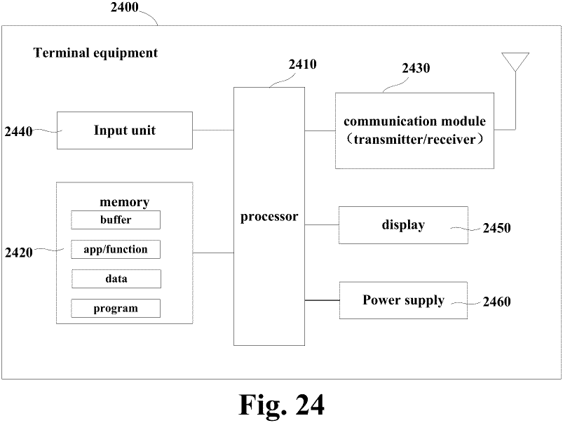

An embodiment of this disclosure also provides an IAB child node or terminal equipment, however, this disclosure is not limited thereto, and other device may also be provided. The terminal equipment is described below as an example. For the IAB child node, the structure shown in FIG. 24 may be available, or some parts (such as a display 2450) may be omitted.

FIG. 24 is a schematic diagram illustrating terminal equipment according to an embodiment of this disclosure. As shown in FIG. 24, the terminal equipment 2400 may include a processor 2410 and a memory 2420. The memory 2420 stores data and programs, and is coupled to the processor 2410. It should be noted that this figure is illustrative, and other types of structures may be used, so as to supplement or replace this structure and achieve telecommunication functions or other functions.

For example, the processor 2410 may be configured to execute a program in order to implement the IAB communication method in the embodiments of the first aspect. For example, the processor 2410 may be configured to: receive indication information transmitted by a network device; the indication information being used to indicate that an IAB child node or terminal equipment deems that a radio link failure (RLF) is detected or indicate that the IAB child node or the terminal equipment initiates a connection reestablishment in a case where an IAB node where the IAB child node or the terminal equipment is present performs an inter-centralized unit (inter-CU) recovery or migration; and initiate a radio link failure recovery process or a connection reestablishment process.

For another example, the processor 2410 may be configured to execute a program in order to implement the IAB communication method in the embodiments of the second aspect. For example, the processor 2410 may be configured to: receive indication information transmitted by a network device; the indication information being used to indicate configuration information of a target-centralized unit (target CU) to which an IAB child node or terminal equipment corresponds in a case where an IAB node where the IAB child node or the terminal equipment is present performs an inter-centralized unit (inter-CU) recovery or migration; and perform communication according to the configuration information of the target CU.

As shown in FIG. 24, the terminal equipment 2400 may further include: a communication module 2430, an input unit 2440, a display 2450 and a power supply 2460; wherein functions of the above components are similar to those in the relevant art, which shall not be described herein any further. It should be noted that the terminal equipment 2400 does not necessarily include all the parts shown in FIG. 24, and the above components are not necessary. Furthermore, the terminal equipment 2400 may also include parts not shown in FIG. 24, and the relevant art may be referred to.

An embodiment of this disclosure further provides a computer program, which, when executed in an IAB child node or terminal equipment, will cause the IAB child node or the terminal equipment to implement the IAB communication method in the embodiments of the first and second aspects.

An embodiment of this disclosure further provides a storage medium storing a computer program, wherein the computer program enables an IAB child node or terminal equipment to implement the IAB communication method in the embodiments of the first and second aspects.

An embodiment of this disclosure further provides a computer program, wherein when the program is executed in an IAB node, the program enables the IAB node to implement the IAB communication method in the embodiments of the first to fourth aspects.

An embodiment of this disclosure further provides a storage medium storing a computer program, wherein the computer program enables an IAB node to implement the IAB communication method in the embodiments of the first to fourth aspects.

The above devices and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/devices described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

As to implementations containing the above embodiments, following supplements are further disclosed.

1. An integrated access and backhaul (IAB) communication method, including:
receiving, by an IAB child node or terminal equipment, indication information transmitted by a network device, the indication information being used to indicate that the IAB child node or the terminal equipment deems that a radio link failure (RLF) is detected or indicate that the IAB child node or the terminal equipment initiates a connection reestablishment in a case where an IAB node where the IAB child node or the terminal equipment is present performs an inter-centralized unit (inter-CU) recovery or migration; and
initiating, by the IAB child node or the terminal equipment, a radio link failure recovery process or a connection reestablishment process.

2. The method according to supplement 1, wherein the indication information is first indication information transmitted by an IAB node of an inter-centralized unit (inter-CU) performing a radio link failure (RLF) recovery or a conditional handover (CHO) migration.

3. The method according to supplement 2, wherein during or after the inter-centralized unit (inter-CU) performs a radio link failure (RLF) recovery process, in a case where the IAB node receives a radio resource control reestablishment (RRC reestablishment) message transmitted by a target centralized unit (target CU), or establishes an F1 interface with the target CU, or receives backhaul (BH) configuration information, the IAB node transmits the first indication information to the IAB child node or the terminal equipment.

4. The method according to supplement 2, wherein during or after the inter-centralized unit (inter-CU) performs a conditional handover (CHO) migration process, in a case where the IAB node initiates a conditional handover (CHO), or transmits a radio resource control reconfiguration complete (RRC reconfiguration complete) message, or establishes an F1 interface with the target CU, or receives BH configuration information, the IAB node transmits the first indication information to the IAB child node or the terminal equipment.

5. The method according to supplement 3 or 4, wherein the method further includes:

in a case where the IAB child node or the terminal equipment is configured with single-connectivity, or the IAB child node or the terminal equipment is configured with dual-connectivity and the IAB node is a master cell group (MCG) of the IAB child node or the terminal equipment, deeming (determining), by the IAB child node or the terminal equipment, that a radio link failure (RLF) is detected for the MCG.

6. The method according to supplement 5, wherein initiating, by the IAB child node or the terminal equipment, a radio link failure recovery process, includes:

in a case where a timer (T316) is configured, a secondary cell group (SCG) transmission is not suspended and a primary serving cell change (PSCell change) is not in progress, initiating, by the IAB child node or the terminal equipment, a MCG failure information process to report a MCG radio link failure, otherwise, initiating the connection reestablishment process.

7. The method according to supplement 3 or 4, wherein the method further includes:

in a case where the IAB child node or the terminal equipment is configured with dual connectivity and the IAB node is a secondary cell group (SCG) of the IAB child node or the terminal equipment, determining, by the IAB child node or the terminal equipment, that a radio link failure (RLF) is detected for the SCG.

8. The method according to supplement 7, wherein initiating, by the IAB child node or the terminal equipment, a radio link failure recovery process, includes:

in a case where a MCG transmission is not suspended, initiating, by the IAB child node or the terminal equipment, a SCG failure information process to report a SCG radio link failure, otherwise initiating the connection reestablishment process.

9. The method according to any one of supplements 2 to 8, wherein the first indication information includes at least one or any combination of: a backhaul adaptation protocol (BAP) protocol data unit (PDU), a radio link control (RLC) PDU, a medium access control (MAC) control element (CE), a medium access control (MAC) subheader, or physical layer signaling.

10. The method according to supplement 1, wherein the indication information is third indication information transmitted via a recovered or migrated path by a source centralized unit (source CU) of an inter-centralized unit (inter-CU) performing a radio link failure (RLF) recovery or a conditional handover (CHO) migration.

11. The method according to supplement 10, wherein the source centralized unit (CU) transmits the third indication information to a target CU or a distributed unit (DU) of the IAB node via an Xn interface, and the target CU or the DU transmits the third indication information to the IAB child node or the terminal equipment.

12. The method according to supplement 10 or 11, wherein during or after the inter-centralized unit (inter-CU) performs a radio link failure (RLF) recovery process, in a case where the source CU receives a retrieval context request message transmitted by the target CU, or transmits a retrieval context response message to the target CU, or receives a context release message transmitted by the target CU, transmitting, by the source CU, the third indication information.

13. The method according to supplement 10 or 11, wherein during or after the inter-centralized unit (inter-CU) performs a conditional handover (CHO) migration process, in a case where the source CU receives the context release message transmitted by the target CU, transmitting the third indication information.

14. The method according to supplement 12 or 13, wherein the method further includes:

in a case where the IAB child node or the terminal equipment is configured with single-connectivity, or the IAB child node or the terminal equipment is configured with dual-connectivity and the IAB node is a master cell group (MCG) of the IAB child node or the terminal equipment, determining, by the IAB child node or the terminal equipment, that a radio link failure (RLF) is detected for the MCG.

15. The method according to supplement 14, wherein initiating, by the IAB child node or the terminal equipment, a radio link failure recovery process, includes:

in a case where a timer (T316) is configured, a secondary cell group (SCG) transmission is not suspended and a primary serving cell change (PSCell change) is not in progress, initiating, by the IAB child node or the terminal equipment, a MCG failure information process to report a MCG radio link failure, otherwise, initiating the connection reestablishment process.

16. The method according to supplement 12 or 13, wherein the method further includes:

in a case where the IAB child node or the terminal equipment is configured with dual connectivity and the IAB node is a secondary cell group (SCG) of the IAB child node or the terminal equipment, determining, by the IAB child node or the terminal equipment, that a radio link failure (RLF) is detected for the SCG.

17. The method according to supplement 16, wherein initiating, by the IAB child node or the terminal equipment, a radio link failure recovery process, includes:

in a case where the MCG transmission is not suspended, initiating, by the IAB child node or the terminal equipment, a SCG failure information process to report a SCG radio link failure, otherwise, initiating the connection reestablishment process.

18. The method according to any one of supplements 10 to 17, wherein the third indication information includes at least one or any combination of: a packet data convergence protocol (PDCP) protocol data unit (PDU), a radio resource control (RRC) message, or an F1AP message.

19. An integrated access and backhaul (IAB) communication method, including:
receiving, by an IAB child node or terminal equipment, indication information transmitted by a network device, the indication information being used to indicate configuration information of a target CU to which the IAB child node or the terminal equipment corresponds in a case where an IAB node where the IAB child node or the terminal equipment is present performs an inter-centralized unit (inter-CU) recovery or migration; and
performing communication, by the IAB child node or the terminal equipment, according to the configuration information of the target CU.

20. The method according to supplement 19, wherein the indication information is second indication information transmitted by the target CU of an inter-centralized unit (inter-CU) performing a radio link failure (RLF) recovery or a conditional handover (CHO) migration.

21. The method according to supplement 20, wherein during or after the inter-centralized unit (inter-CU) performs a radio link failure (RLF) recovery process, in a case where the target CU transmits a radio resource control reestablishment (RRC reestablishment) message, or receives a radio resource control reestablishment complete (RRC reestablishment complete) message, or establishes an F1 interface with the IAB node, or transmits BH configuration information, transmitting, by the target CU, the second indication information to the IAB child node or the terminal equipment.

22. The method according to supplement 20, wherein during or after the inter-centralized unit (inter-CU) performs a conditional handover (CHO) migration process, in a case where the target CU receives a radio resource control reestablishment complete message, or establishes an F1 interface with the IAB node, or transmits BH configuration information, transmitting, by the target CU, the second indication information to the IAB child node or the terminal equipment.

23. The method according to any one of supplements 20 to 22, wherein the second indication information indicates configuration information of a radio resource control (RRC) layer and/or a packet data convergence protocol (PDCP) layer in the target CU.

24. The method according to any one of supplements 20 to 23, wherein the second indication information includes at least one or any combination of: a nextHopChainingCount, a keySetChangeIndicator, non-access stratum (NAS) security information (NAS-Container), a ciphering Algorithm, or an integrityProtAlgorithm.

25. The method according to any one of supplements 20 to 24, wherein the target CU transmits the second indication information that is deciphered or default ciphered to the IAB Child node or the terminal equipment by using a radio resource control (RRC) message.

26. The method according to supplement 25, wherein the method further includes:
receiving, by the IAB child node or the terminal equipment, a notification message of the IAB node; and
suspending, by the IAB child node or the terminal equipment, integrity protection and ciphering operations for a signaling radio bearer (SRB) according to the notification message to obtain the second indication information.

27. The method according to supplement 25, wherein the method further includes:
performing, by the IAB child node or the terminal equipment, deciphering and decoding operations for the radio resource control (RRC) message;
in a case of unsuccessful decoding, not performing deciphering or default deciphering for the radio resource control (RRC) message; and
performing a decoding operation to obtain the second indication information.

28. The method according to any one of supplements 20 to 24, wherein the target CU transmits the second indication information to the IAB child node or the terminal equipment using configuration information of the source CU by using a radio resource control (RRC) message.

29. The method according to any one of supplements 20 to 24, wherein the target CU transmits the second indication information to the source CU via an Xn interface, and after the source CU processes the second indication information by using the configuration information, the source CU transmits it to the IAB child node or the terminal equipment via a recovered or migrated path.

30. The method according to any one of supplements 20 to 24, wherein the target CU transmits the second indication information to the IAB child node or the terminal equipment by using an F1AP message.

31. The method according to any one of supplements 20 to 24, wherein the target CU transmits the second indication information to the source CU via an Xn interface, and the source CU transmits the second indication information to a DU of the IAB node by using an F1AP message, and the DU of the IAB node transmits it to the IAB child node or the terminal equipment.

32. The method according to supplement 19, wherein the indication information is fourth indication information transmitted by a source CU of an inter-centralized unit (inter-CU) performing a radio link failure (RLF) recovery or a conditional handover (CHO) migration.

33. The method according to supplement 32, wherein during or after the inter-centralized unit (inter-CU) performs a radio link failure (RLF) recovery process, in a case where a target CU transmits a radio resource control reestablishment (RRC reestablishment) message, or receives a radio resource control reestablishment complete (RRC reestablishment complete) message, or establishes an F1 interface with the IAB node, or transmits BH configuration information, the source CU transmits the fourth indication information to the IAB child node or the terminal equipment.

34. The method according to supplement 32, wherein during or after the inter-centralized unit (inter-CU) performs a conditional handover (CHO) migration process, in a case where a target CU receives a radio resource control reconfiguration complete message, or establishes an F1 interface with the IAB node, or transmits BH configuration information, the source CU transmits the fourth indication information to the IAB child node or the terminal equipment.

35. The method according to any one of supplements 32 to 34, wherein the fourth indication information indicates configuration information of a radio resource control (RRC) layer and/or a packet data convergence protocol (PDCP) layer in the target CU.

36. The method according to any one of supplements 32 to 35, wherein the fourth indication information includes at least one or any combination of: a nextHopChainingCount, a keySet ChangeIndicator, non-access stratum (NAS) security information (NAS-Container), a ciphering Algorithm, or an integrityProtAlgorithm.

37. The method according to any one of supplements 32 to 36, wherein the source CU receives the fourth indication information transmitted by the target CU by using a radio resource control (RRC) message, after the source CU processes the fourth indication information by using the configuration information, the source CU transmits it to a DU of the IAB node via an Xn interface, and the DU of the IAB node transmits it to the IAB child node or the terminal equipment.

38. An integrated access and backhaul (IAB) communication method, including:
generating, by a network device, indication information, the indication information being used to indicate that an IAB child node or terminal equipment deems that a radio link failure (RLF) is detected or indicate that the IAB child node or the terminal equipment initiates a connection reestablishment in a case where an IAB node where the IAB child node or the terminal equipment is present performs an inter-centralized unit (inter-CU) recovery or migration; and
transmitting the indication information to the IAB child node or the terminal equipment.

39. The method according to supplement 38, wherein the network device is an IAB node of an inter-centralized unit (inter-CU) performing a radio link failure (RLF) recovery or a conditional handover (CHO) migration; the indication information is first indication information transmitted by the IAB node of the inter-centralized unit (inter-CU) performing the radio link failure (RLF) recovery or the conditional handover (CHO) migration.

40. The method according to supplement 39, wherein during or after the inter-centralized unit (inter-CU) performs a radio link failure (RLF) recovery process, in a case where the IAB node receives a radio resource control reestablishment (RRC reestablishment) message transmitted by a target centralized unit (target CU), or establishes an F1 interface with the target CU, or receives backhaul (BH) configuration information, the IAB node transmits the first indication information to the IAB child node or the terminal equipment.

41. The method according to supplement 39, wherein during or after the inter-centralized unit (inter-CU) performs a conditional handover (CHO) migration process, in a case where the IAB node initiates a conditional handover (CHO), or transmits a radio resource control reconfiguration complete (RRC reconfiguration complete) message, or establishes an F1 interface with the target CU, or receives BH configuration information, the IAB node transmits the first indication information to the IAB child node or the terminal equipment.

42. The method according to any one of supplements 39 to 42, wherein the first indication information includes at least one or any combination of: a backhaul adaptation protocol (BAP) protocol data unit (PDU), a radio link control (RLC) PDU, a medium access control (MAC) control element (CE), a medium access control (MAC) subheader, or physical layer signaling.

43. The method according to supplement 38, wherein the network device is a source CU of an inter-centralized unit (inter-CU) performing a radio link failure (RLF) recovery or a conditional handover (CHO) migration; the indication information is third indication information transmitted via a recovered or migrated path by the source centralized unit (source CU) of the inter-centralized unit (inter-CU) performing the radio link failure (RLF) recovery or the conditional handover (CHO) migration.

44. The method according to supplement 43, wherein the source centralized unit (CU) transmits the third indication information to a target CU or a distributed unit (DU) of the IAB node via an Xn interface, and the target CU or the DU transmits the third indication information to the IAB child node or the terminal equipment.

45. The method according to supplement 43 or 44, wherein during or after the inter-centralized unit (inter-CU) performs a radio link failure (RLF) recovery process, in a case where the source CU receives a retrieval context request message transmitted by the target CU, or in a case where a retrieval context response message is transmitted to the target CU, or in a case where a context release message transmitted by the target CU is received, the source CU transmits the third indication information.

46. The method according to supplement 43 or 44, wherein during or after the inter-centralized unit (inter-CU) performs a conditional handover (CHO) migration process, in a case where the source CU receives the context release message transmitted by the target CU, the source CU transmits the third indication information.

47. The method according to any one of supplements 43 to 46, wherein the third indication information includes at least one or any combination of: a packet data convergence protocol (PDCP) protocol data unit (PDU), a radio resource control (RRC) message, or an F1AP message.

48. An integrated access and backhaul (IAB) communication method, including:
generating, by a network device, indication information, the indication information being used to indicate configuration information of a target-centralized unit to which an IAB child node or terminal equipment corresponds in a case where an IAB node where the IAB child node or the terminal equipment is present performs an inter-centralized unit (inter-CU) recovery or migration; and
transmitting the configuration information of the target CU to the IAB child node or the terminal equipment.

49. The method according to supplement 48, wherein the network device is a target CU of an inter-centralized unit (inter-CU) performing a radio link failure (RLF) recovery or a conditional handover (CHO) migration; the indication information being second indication information transmitted by the target CU of the inter-centralized unit (inter-CU) performing the radio link failure (RLF) recovery or the conditional handover (CHO) migration.

50. The method according to supplement 49, wherein during or after the inter-centralized unit (inter-CU) performs a radio link failure (RLF) recovery process, in a case where the target CU transmits a radio resource control reestablishment (RRC reestablishment) message, or receives a radio resource control reestablishment complete (RRC reestablishment complete) message, or establishes an F1 interface with the IAB node, or transmits BH configuration information, the target CU transmits the second indication information to the IAB child node or the terminal equipment.

51. The method according to supplement 49, wherein during or after the inter-centralized unit (inter-CU) performs a conditional handover (CHO) migration process, in a case where the target CU receives a radio resource control reestablishment (RRC reestablishment) message, or establishes an F1 interface with the IAB node, or transmits BH configuration information, the target CU transmits the second indication information to the IAB child node or the terminal equipment.

52. The method according to any one of supplements 49 to 51, wherein the second indication information indicates configuration information of a radio resource control (RRC) layer and/or a packet data convergence protocol (PDCP) layer in the target CU.

53. The method according to any one of supplements 49 to 52, wherein the second indication information includes at least one or any combination of: a nextHopChainingCount, a keySetChangeIndicator, non-access stratum (NAS) security information (NAS-Container), a ciphering Algorithm, or an integrityProtAlgorithm.

54. The method according to any one of supplements 49 to 53, wherein the target CU transmits the second indication information that is deciphered or default ciphered to the IAB child node or the terminal equipment by using a radio resource control (RRC) message.

55. The method according to any one of supplements 49 to 53, wherein the target CU transmits the second indication information to the IAB child node or the terminal equipment via a radio resource control (RRC) message by using configuration information of the source CU.

56. The method according to any one of supplements 49 to 53, wherein the target CU transmits the second indication information to the source CU via an Xn interface, and after the source CU processes the second indication information by using configuration information, the source CU transmits it to the IAB child node or the terminal equipment via a recovered or migrated path.

57. The method according to any one of supplements 49 to 53, wherein the target CU transmits the second indication information to the IAB child node or the terminal equipment by using an F1AP message.

58. The method according to any one of supplements 49 to 53, wherein the target CU transmits the second indication information to the source CU via an Xn interface, and the source CU transmits the second indication information to a distributed unit (DU) of the IAB node by using an F1AP message, and the DU of the IAB node transmits the second indication information to the IAB child node or the terminal equipment.

59. The method according to supplement 48, wherein the network device is a source CU of an inter-centralized unit (inter-CU) performing a radio link failure (RLF) recovery or a conditional handover (CHO) migration; the indication information is fourth indication information transmitted by the source CU of the inter-centralized unit (inter-CU) performing the radio link failure (RLF) recovery or the conditional handover (CHO) migration.

60. The method according to supplement 59, wherein during or after the inter-centralized unit (inter-CU) performs a radio link failure (RLF) recovery process, in a case where a target CU transmits a radio resource control reestablishment (RRC reestablishment) message, or receives a radio resource control reestablishment complete (RRC reestablishment complete) message, or establishes an F1 interface with the IAB node, or transmits BH configuration information, the source CU transmits the fourth indication information to the IAB child node or the terminal equipment.

61. The method according to supplement 59, wherein during or after the inter-centralized unit (inter-CU) performs a conditional handover (CHO) migration process, in a case where a target CU receives a radio resource control reconfiguration complete message, or establishes an F1 interface with the IAB node, or transmits BH configuration information, the source CU transmits the fourth indication information to the IAB child node or the terminal equipment.

62. The method according to any one of supplements 59 to 61, wherein the fourth indication information indicates configuration information of a radio resource control (RRC) layer and/or a packet data convergence protocol (PDCP) layer in the target CU.

63. The method according to any one of supplements 59 to 62, wherein the fourth indication information includes at least one or any combination of: a nextHopChainingCount, a keySet ChangeIndicator, non-access stratum (NAS) security information (NAS-Container), a ciphering Algorithm, or an integrityProtAlgorithm.

64. The method according to any one of supplements 59 to 63, wherein the source CU receives the fourth indication information transmitted by the target CU by using a radio resource control (RRC) message, after the source CU processes the fourth indication information by using configuration information, the source CU transmits it to a distributed unit of the IAB node via an Xn interface, and the DU of the IAB node transmits it to the IAB child node or the terminal equipment.

65. An integrated access and backhaul (IAB) communication method, including:
detecting, by an IAB node, that in a backhaul link between the IAB node and a parent node, a radio link failure (RLF) occurs or a RLF recovery is being attempted or the RLF recovery successes or the RLF recovery fails; and
transmitting, by the IAB node, RLF indication information to an affiliated IAB child node or terminal equipment; the RLF indication information indicating one of at least two types of backhaul link radio link failure (BH RLF).

66. The method according to supplement 65, wherein the type of backhaul link radio link failure includes at least one of:
type 1 backhaul link radio link failure, which indicates that the IAB node detects that the radio link failure (RLF) occurs in the backhaul link between the IAB node and the parent node,
type 2 backhaul link radio link failure, which indicates that the IAB node detects that the radio link failure (RLF) occurs in the backhaul link between the IAB node and the parent node and the IAB node is attempting the RLF recovery,
type 3 backhaul link radio link failure, which indicates that the IAB node detects that the radio link failure (RLF) occurs in the backhaul link between the IAB node and the parent node and the RLF recovery of the IAB node successes,
type 4 backhaul link radio link failure, which indicates that the IAB node detects that the radio link failure (RLF) occurs in the backhaul link between the IAB node and the parent node and the RLF recovery of the IAB node fails.

67. The method according to supplement 66, wherein the RLF indication information is transmitted to the IAB child node or the terminal equipment by using a BAP control PDU; a PDU type field in the BAP control PDU indicates the type of backhaul link radio link failure.

68. The method according to supplement 67, wherein one value of more than one bit in the PDU type field in the BAP control PDU indicates the type 4 backhaul link radio link failure; and the other value indicates the type 2 backhaul link radio link failure or the type 3 backhaul link radio link failure.

69. The method according to supplement 67, wherein one value of the plurality of bits in the PDU type field in the BAP control PDU indicates the type 4 backhaul link radio link failure; other value indicates the type 2 backhaul link radio link failure; and another value indicates the type 3 backhaul link radio link failure.

70. The method according to supplement 66, wherein a R field in the BAP control PDU using the RLF indication information indicates the at least two types of backhaul link radio link failure.

71. The method according to supplement 70, wherein one value of 1 bit in the R field in the BAP control PDU indicates the type 4 backhaul link radio link failure; and the other value indicates the type 2 backhaul link radio link failure or the type 3 backhaul link radio link failure.

72. The method according to supplement 70, wherein one value of the plurality of bits in the R field in the BAP control PDU indicates the type 4 backhaul link radio link failure; other value indicates the type 2 backhaul link radio link failure; and another value indicates the type 3 backhaul link radio link failure.

73. An integrated access and backhaul (IAB) communication method, including:
detecting, by an IAB node, that in a backhaul link between the IAB node and a parent node, a radio link failure (RLF) occurs or a RLF recovery is being attempted or the RLF recovery successes or the RLF recovery fails; and
transmitting, by the IAB node, the RLF indication information to served terminal equipment by using physical layer signaling, MAC layer signaling, RLC layer signaling or system information.

74. The method according to supplement 73, wherein the physical layer signaling includes a downlink control information (DCI) format, the downlink control information (DCI) indicating a type of backhaul link radio link failure.

75. The method according to supplement 73, wherein the MAC layer signaling includes a MAC CE;

one or more bits or one field in the MAC CE indicates the type of backhaul link radio link failure.

76. The method according to supplement 73, wherein the RLC layer signaling includes a RLC control PDU.

77. The method according to supplement 73, wherein the system information includes: a master information block (MIB) and/or a system information block (SIB); one field in the MIB and/or the SIB indicates a type of backhaul link radio link failure.

78. The method according to supplement 77, wherein a cell barred field (cellBarred) in the MIB is set to be barred or an IAB support field (IAB-support) in the SIB does not appear.

79. An IAB child node or terminal equipment, including: a memory and a processor, wherein the memory stores a computer program, and the processor is configured to execute the computer program so as to implement the IAB communication method according to any one of supplements 1 to 37.

80. A network device including: a memory and a processor, wherein the memory stores a computer program, and the processor is configured to execute the computer program so as to implement the IAB communication method according to any one of supplements 38 to 78.

81. A communication system, including:
an IAB child node or terminal equipment, which implements the IAB communication method according to any one of supplements 1 to 37; and
a network device, which implements the IAB communication method according to any one of supplements 38 to 64.

82. A communication system, including:

an IAB node, which implements the IAB communication method according to any one of supplements 65 to 78.

What is claimed is:

1. An integrated access and backhaul (IAB) communication method, comprising:
detecting, by an IAB node, that on a backhaul link between the IAB node and a parent node, a radio link failure (RLF) occurs or a radio link failure (RLF) recovery is successful, or a radio link failure (RLF) recovery is failure; and
transmitting, by the IAB node, RLF indication information to an IAB child node or a terminal equipment by using a Backhaul Adaptation Protocol (BAP) control Protocol Data Unit (PDU), the RLF indication information being used for indicating one of at least two backhaul radio link failure (BH RLF) types.

2. The method according to claim 1, wherein the backhaul radio link failure (BH RLF) type comprises at least one of:
a first type of backhaul radio link failure (BH RLF) denoting the IAB node detected that a radio link failure (RLF) occurs on a backhaul link between the IAB node and a parent node;
a second type of backhaul radio link failure (BH RLF) denoting the IAB node detected that a radio link failure (RLF) occurs on a backhaul link between the IAB node and a parent node, and a radio link failure (RLF) recovery is successful; or
a third type of backhaul radio link failure (BH RLF) denoting the IAB node detected that a radio link failure (RLF) occurs on a backhaul link between the IAB node and a parent node, and a radio link failure (RLF) recovery is failure.

3. The method according to claim 1, wherein the BAP control PDU is constructed to transmit the RLF indication information, wherein a field indicates a type of control information included in the BAP control PDU.

4. The method according to claim 3, wherein the RLF indication information is BH RLF indication indicated by the field.

5. The method according to claim 3, wherein the RLF indication information is BH RLF detection indication indicated by the field.

6. The method according to claim 3, wherein the RLF indication information is BH RLF recovery indication indicated by the field.

7. The method according to claim 3, wherein a plurality of bits in the field of the BAP control PDU indicates the at least two backhaul radio link failure (BH RLF) type.

8. The method according to claim 7, wherein a value of the plurality of bits indicates BH RLF indication, another value of the plurality of bits indicates BH RLF detection indication, another value of the plurality of bits indicates BH RLF recovery indication.

9. The method according to claim 7, wherein 0011 in the field of the BAP control PDU indicates BH RLF indication, 0100 in the field of the BAP control PDU indicates BH RLF detection indication, 0101 in the field of the BAP control PDU indicates BH RLF recovery indication.

10. The method according to claim 7, wherein 0011 in the field of the BAP control PDU indicates a third type of backhaul radio link failure (BH RLF), 0100 in the field of the BAP control PDU indicates a first type of backhaul radio link failure (BH RLF), 0101 in the field of the BAP control PDU indicates a second type of backhaul radio link failure (BH RLF).

11. An apparatus, applicable to an integrated access and backhaul (IAB) communication device, the apparatus comprising;
processor circuitry configured to detect that on a backhaul link between a IAB node and a parent node, a radio link failure (RLF) occurs or a radio link failure (RLF) recovery is successful, or a radio link recovery (RLF) recovery is failure, and
a transmitter configured to transmit RLF indication information to an IAB child node or a terminal equipment by using a BAP control PDU; the RLF indication information being used for indicating one of at least two backhaul radio link failure (BH RLF) type.

12. The apparatus according to claim 11, wherein the backhaul radio link failure (BH RLF) type comprises at least one of:
a first type of backhaul radio link failure (BH RLF) denoting the IAB node detected that a radio link failure (RLF) occurs on a backhaul link between the IAB node and a parent node;
a second type of backhaul radio link failure (BH RLF) denoting the IAB node detected that a radio link failure (RLF) occurs on a backhaul link between the IAB node and a parent node, and a radio link failure (RLF) recovery is successful; or
a third type of backhaul radio link failure (BH RLF) denoting the IAB node detected that a radio link failure (RLF) occurs on a backhaul link between the IAB node and a parent node, and a radio link failure (RLF) recovery is failure.

13. The apparatus according to claim 11, wherein the BAP control PDU is constructed to transmit the RLF indication information, wherein a field indicates a type of control information included in the BAP control PDU.

14. The apparatus according to claim 13,
wherein the RLF indication information is BH RLF indication indicated by the field, or
the RLF indication information is BH RLF detection indication indicated by the field, or
the RLF indication information is BH RLF recovery indication indicated by the field.

15. The apparatus according to claim 13, wherein a plurality of bits in the field of the BAP control PDU indicates the at least two backhaul radio link failure (BH RLF) type.

16. The apparatus according to claim 15, wherein a value of the plurality of bits indicates BH RLF indication, another value of the plurality of bits indicates BH RLF detection indication, another value of the plurality of bits indicates BH RLF recovery indication.

17. The apparatus according to claim 15, wherein 0011 in the field of the BAP control PDU indicates BH RLF indication, 0100 in the field of the BAP control PDU indicates BH RLF detection indication, 0101 in the field of the BAP control PDU indicates BH RLF recovery indication.

18. The apparatus according to claim 15, wherein 0011 in the field of the BAP control PDU indicates a third type of backhaul radio link failure (BH RLF), 0100 in the field of the BAP control PDU indicates a first type of backhaul radio link failure (BH RLF), 0101 in the field of the BAP control PDU indicates a second type of backhaul radio link failure (BH RLF).

19. A communication system, comprising:
an IAB node configured to:
detect that on a backhaul link between the IAB node and a parent node, a radio link failure (RLF) occurs or a radio link failure (RLF) recovery is successful, or a radio link failure (RLF) recovery is failure, and
transmit RLF indication information to an IAB child node or a terminal equipment by using a BAP control PDU; the RLF indication information being used for indicating one of at least two backhaul radio link failure (BH RLF) type.
